(19) United States
(12) Patent Application Publication
(10) Pub. No.: US 2026/0370412 A1
(43) Pub. Date: Nov. 19, 2026

(54) OPTIMIZED RESOURCE MANAGEMENT AND ENHANCED EFFICIENCY IN JOINT COMMUNICATION AND SENSING SYSTEMS

(71) Applicant: INTEL CORPORATION, Santa Clara, CA (US)

(72) Inventors: Fatemeh HAMIDI-SEPEHR, San Jose, CA (US); Thushara HEWAVITHANA, Chandler, AZ (US); Mark A. LEHNE, Hillsboro, OR (US); Qian LI, Portland, OR (US)

(73) Assignee: INTEL CORPORATION, Santa Clara, CA (US)

(21) Appl. No.: 19/143,091

(22) PCT Filed: Dec. 21, 2023
(86) PCT No.: PCT/US2023/085356

§ 371 Date: Jun. 25, 2025

Related U.S. Application Data
(60) Provisional application No. 63/440,246, filed on Jan. 20, 2023.

(51) Int. Cl. H04L 5/00; H04L 27/26

(52) U.S. Cl. CPC H04L 5/0051; H04L 5/0094; H04L 27/2613

(57) ABSTRACT

This disclosure describes systems, methods, and devices related to enhanced resource usage and management. A device may generate and map sensing modulated symbols to time and frequency resource elements (REs) of an Orthogonal Frequency Division Multiplexing (OFDM) resource grid, following a supported configurations of fifth generation (5G) NR Downlink (DL) Positioning Reference Signal (PRS), or 5G NR Uplink (UL) PRS based on a 5G NR Sounding Reference Signal (SRS), respectively. This disclosure describes the required additional configurations to be supported for such signals, in order to allow more efficient use of air interface resources. Efficient resource utilization can involve altering Doppler processing and radio signal structure for hierarchical sensing, implementing smart FoV scans using preliminary data, or reusing physical resources in varying FoV parts through time or frequency domain shifts, informed by initial environmental and target range findings.

### CROSS-REFERENCE TO RELATED PATENT APPLICATION(S)

This application claims the benefit of U.S. Provisional Application No. 63/440,246, filed Jan. 20, 2023, the disclosure of which is incorporated herein by reference as if set forth in full.

### TECHNICAL FIELD

This disclosure generally relates to systems and methods for wireless communications and, more particularly, to optimized resource management and enhanced efficiency in joint communication and sensing systems.

### BACKGROUND

In the evolving landscape of cellular technology, the fusion of communication and sensing functionalities within the orthogonal frequency division multiplexing (OFDM) framework marks a pivotal development. There is a need for a synergistic integration of sensing signal attributes with resource multiplexing strategies, highlighting an ongoing need for cutting-edge advancements in this dynamic sector.

### BRIEF DESCRIPTION OF THE DRAWINGS

FIGS. 1-8 depict illustrative schematic diagrams for enhanced resource management, in accordance with one or more example embodiments of the present disclosure.

FIG. 9 illustrates a flow diagram of illustrative process for an illustrative enhanced resource management system, in accordance with one or more example embodiments of the present disclosure.

FIG. 10 illustrates an example network architecture, in accordance with one or more example embodiments of the present disclosure.

FIG. 11 schematically illustrates a wireless network, in accordance with one or more example embodiments of the present disclosure.

FIG. 12 illustrates components of a computing device, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes.

In the current disclosure, methods for sensing signal overhead reduction (reducing the physical resources used for sensing) and/or the sensing field of view (FoV) scan time reduction, and/or sensing receiver processing/complexity reduction, are disclosed: One way of the overhead reduction may result from modifications in Doppler processing/estimation, and accordingly, the sensing radio signal structure. Some such methods were discussed in [1], and in this disclosure, methods and techniques to adapt the design of DL-PRS and UL-PRS in order to allow such modified (hierarchal) Doppler estimation are disclosed. The disclosure discusses advanced field of view (FoV) scanning techniques in joint communication and sensing (JCAS) systems. It outlines methods for dynamic FoV scanning, where initial scans guide subsequent, more focused scans. This approach enhances resource efficiency and reduces sensing overhead and time. The text also details the use of downlink (DL) and uplink (UL) positioning reference signals (PRS) in JCAS for various sensing configurations, including mono-static and bi-static sensing. Key challenges in JCAS design, such as flexible operation and interference mitigation, are addressed. The design emphasizes efficient resource use within the orthogonal frequency division multiplexing (OFDM) framework, focusing on the allocation and multiplexing of resources for both communication and sensing. Techniques for extending DL and UL PRS for sensing, and adapting signals like the sounding reference signal (SRS) for different sensing architectures, are also discussed.

Example embodiments of the present disclosure relate to systems, methods, and devices for reduction of sensing resource overhead or control signaling or field-of-view scanning time or receive processing in joint communication and sensing systems. In one or more embodiments, an enhanced resource management system may facilitate sensing frameworks/architectures in cellular systems. Base station-based (e.g., gNodeB (gNB)-based) and user equipment (UE)-based sensing scenarios can exist in a cellular framework, to enable different sensing application and use cases. For example, the following cases can exist:

Case 1: gNB sends the sensing radio signal and receives/measures/processes its reflections from objects/environment, in time, frequency, and spatial/angular domains. If the same gNB also receives/measures/processes the reflected signal, the scenario may be called gNB-based monostatic sensing mode, and if other gNB(s) are involved in receiving, measurement/processing, it may be called gNB-based bi-static (multi-static) sensing mode by cooperative network nodes.

Case 2: gNB sends the sensing radio signal and UE receives/measures/processes its reflections (bi-static sensing mode).

Case 3: UE sends sensing radio signal and same or different UE(s), or gNB(s) receives/measures its reflections (corresponding to UE-based monostatic and UE-based bi/multi-static, or gNB-based bi/multi-static sensing modes, respectively). For cases 1 and 2, the sensing signal can be based on a DL-PRS signal (with some extensions and adaptations or some newly designed sensing signal. There is also possibility of combining cases 1 and/or 2, also with the case where the UE receives/measures gNB's radio signal for the positioning purposes, e.g., when gNB's signal is based on DL PRS signal (which will be thoroughly investigated later). As can be seen from the above cases, sensing may require transmission/reception from multiple nodes to perform coordinated environment or neighborhood perception by multiple gNBs and/or UEs. It is possible for reusing/extending UL-PRS signal design in order to enable Case 3 above. It is also noted that UL-PRS is referred to as “SRS for positioning.”

In order to enable sensing functionality addressing different use-cases (UCs) with corresponding sensing KPI requirements, the wireless signal used for the purpose of sensing, may meet certain requirements in terms of time domain and frequency domain attributes. Such attributes may determine the underlying numerologies, frame structures, and/or physical resource assignments and patterns. These aspects may be described with respect to various embodiments, and the required attributes and properties of air-interface signal used for sensing to meet range, speed, and angular requirements are derived. These characteristics may be applicable to signal transmitted from gNB and/or UE. Comprehensive designs for Downlink positioning reference signal (DL-PRS) are provided, focusing on necessary adaptations to achieve desired attributes for effective sensing applications. These designs include scenarios where the transmission of User Equipment's (UE's) radio signal is crucial for sensing. Strategic development of signal structures and attributes for sensing detection is a crucial element. This includes the innovative adaptation and extension of UL sounding reference signal structures to Uplink positioning reference signal (UL-PRS), based on sounding reference signals (SRS). Additionally, detailed designs for both DL-PRS and UL-PRS signal systems are presented. The relationship between signal characteristics and the configuration of the sensing frame is thoroughly explained. This framework enhances the efficiency and effectiveness of signal design in telecommunications, particularly in improving sensing capabilities through advanced signal processing methodologies. By enabling DL-PRS-based sensing, the JCAS system may support both base station (BS)-based monostatic sensing and UE-based bi-static sensing of the environment (BS being the DL-PRS signal transmitter, and UE being DL-PRS signal sensing receiver), as well as UE-based positioning. Similarly, by enabling UL-PRS-based sensing, the JCAS system may support both UE-based monostatic sensing and BS-based bi-static sensing of the environment (UE being the UL-PRS signal transmitter, and BS being UL-PRS signal sensing receiver), as well as BS-based positioning. As such, throughout this disclosure, whenever the discussion concerns DL-PRS, the focus can be either/both BS-based monostatic sensing and UE-based bi-static sensing, and whenever the discussion concerns UL-PRS, the focus can be either/both UE-based monostatic sensing and BS-based bi-static sensing. The current disclosure relates to techniques for sensing signal overhead reduction (reducing the physical resources used for sensing) and/or the sensing field of view (FoV) scan time reduction, and/or sensing receiver processing/complexity reduction.

In one or more embodiments, an enhanced resource management system may facilitate that one way of the overhead reduction may result from modifications in Doppler processing/estimation, and accordingly, the sensing radio signal structure. In one or more embodiments, an enhanced resource management system may retained techniques to adapt the design of DL-PRS and UL-PRS in order to allow such modified (hierarchal) Doppler estimation are disclosed.

In one or more embodiments, an enhanced resource management system may facilitate for allowing dynamic FoV scans are discussed/disclosed. For example, preliminary FoV scan(s) (e.g., through beam sweeping), followed by adjusted/adapted FoV scan based on the collected information from the preliminary scan(s) can be performed. Such approaches can result in smarter consequent scans, helping with more efficient use of resource for sensing. Particularly, it is possible to design the system to support more focused FOV scans, e.g., such that previous measurements help narrow down the search space to fine tuning the directions to sense/scan without sweeping the entire FoV (just sweep on a specific/selected few identified beams). Accordingly, the resulting sensing overhead and also the overall time that needed to sense the desired environment can be reduced. To enable such dynamic approaches, proper control signaling is also disclosed.

In one or more embodiments, an enhanced resource management system may facilitate techniques to enable reusing physical resources for sensing in different parts of FoV are disclosed, e.g., based on some preliminary knowledge gathered regarding the environment and target ranges in initial scan(s) of FoV.

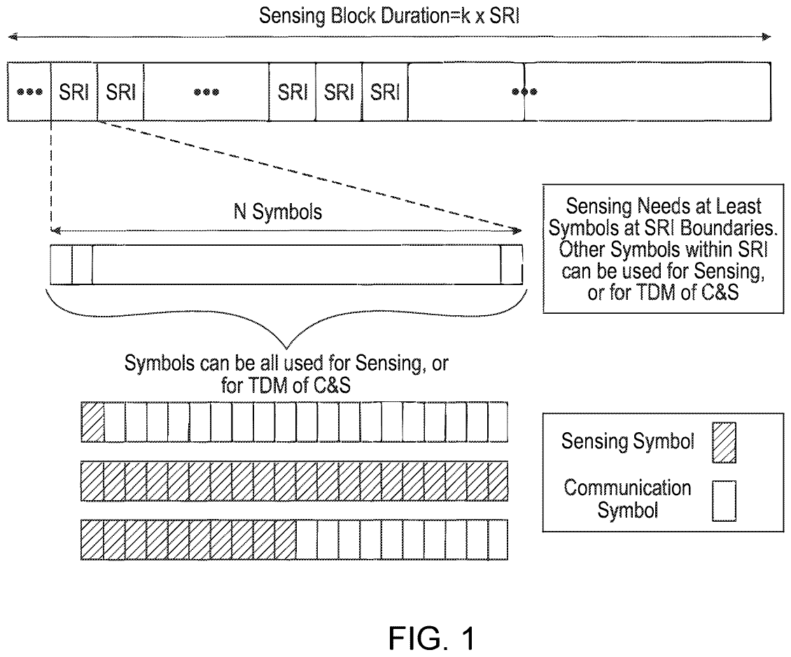

As an example of Legacy Doppler processing for radar sensing, when Translating sensing speed requirements into time domain (TD) signal properties, there may be two example time domain resource assignment properties for sensing signal to enable Doppler processing (FIG. 1):
The integration time span over which, the sensing signal shall extend when computing the Doppler profile, called the sensing block duration which is equal to c₀/(2f_{c}Δν); and is inversely proportional to the velocity resolution and the carrier frequency.
The maximum time spacing between the sensing symbols within the span of sensing block to enable the Doppler estimation per beam direction, which is called symbol repetition interval (SRI), and is equal to c₀/(4f_{c}νₘₐₓ)′ which is inversely proportional to the maximum detectable speed and the carrier frequency. SRI can be seen as a Nyquist sampling rate for the maximum speed detection. Besides this factor, there are also other limits on the detectable speed, and the maximum detectable speed to meet SRI Nyquist rate, ICI condition (SCS~10% of Doppler frequency), and the range migration condition is νₘₐₓ≤Min

$$( \frac{{c}_{0}}{4 {f}_{c} {T}_{SRI}} , \frac{Δ d}{k \times {T}_{SRI}} , \frac{{c}_{0} \times SCS}{20 \times {f}_{c}} ) .$$

It is also noted that the sensing block duration equals to an integer multiply the SRI, and that integer value, k, is the Doppler FFT size in the receive processing.

The above two, are the fundamental requirements for the sensing signal, in order to perform a single task of sensing per beam direction. The basic allocation scheme is for a single beam, and can then be extended to the case of beam sweeping to scan the FoV.

In one or more embodiments, an enhanced resource management system may facilitate a modified sensing signal structure for modified Doppler processing.

With the above legacy sensing frame structure, during each sensing block (k*SRI), for each scanned beam direction, the targets' range and speed are calculated. In the best case where it is possible to accommodate all the beams to cover FoV in SRI, within one block of k*SRI, the range/speed estimation is done over the FoV, within the sensing block. Even in such cases, usually there may not be much likelihood of multiplexing communication in between the sensing symbols within the SRI. In other cases, there may not be even possible to cover all the directions in the FoV within the SRI, which would limit the scanning capability. The question which is raised is now “Is it possible to transmit and/or process differently?” For example, is it possible to re-order the Doppler estimation and FoV scan, etc., and would it help with either reduction of the sensing transmission overhead or FoV scan time, or receiver processing?

As another example, is it possible that at least for certain (e.g., low-speed) use-cases, e.g., the car park scenario, snapshots of the environment are taken (the entire FoV is scanned), without estimating Doppler in each snapshot, but the Doppler being estimated between the frames (snapshots)? For example, in between the snapshots, some post processing is performed to figure out the Doppler, due to the targets' movement, e.g., one may interpret the speed based on the difference of the range in two scans/snapshots, etc.

Further, it may be possible to narrow down or adjust the snapshots (the scanned FoV) and not to scan entire FoV over areas that no target is detected in previous snapshot. For example, only if some objects are detected, some beam direction proximity/neighborhood is selected for the next snapshot scans.

It is also noted for positioning scenarios, even though Doppler measurements are not defined for UE positioning, some speed estimation can be done based on the changed location over time.

As such, the Doppler processing may not be able to be performed for every (or any) direction in each scan, or Doppler processing may not be even done at all in the initial scan. If some targets are identified, the range estimation between the snapshots may provide an approximate speed, or Doppler processing may only be proceeded with if the range processing identifies some objects in the first snapshot. These are some examples of potential reordering of FoV scanning and Doppler processing, and may help to prioritize reduction of beam scan latency over speed estimation, while may even save the amount of sensing overhead, and even Doppler processing.

Adjusting FoV snapshots based on previous scans is complemented by a modified Doppler processing technique. This involves assigning different SRI durations to different beam directions or different parts of the FoV, based on the dynamic/static nature of targets in those areas. For example, if a part of the FoV maps to a car park with low-speed objects, longer SRI durations can be assigned to beams directions covering that area. This method enhances sensing flexibility, especially in areas with varying target movement. The concept is applicable to UL-PRS design, allowing for adaptable SRI assignments. Further developments include extensions to DL-PRS, enabling similar flexibility for sensing. These extensions adapt to different object speeds and movements within the FoV, leading to a more adaptable and responsive sensing system, efficiently managing resources across diverse sensing environments.

In one or more embodiments, an enhanced resource management system may facilitate doppler estimation and ambiguity resolution via a two-signal approach.

The following is a description of the doppler ambiguity problem. If the interval to scan a number of beams (with the number of OFDM symbols (OS) corresponding to the number of independent MIMO layers required to scan that beam)) in the FoV is larger than the SRI, then this means that sending all the beams in FoV would span over a larger interval than the SRI, and it is not even possible to fulfill the Doppler Nyquist rate by SRI distance. Then if taking the snapshots back-to-back, effectively, an equivalent SRI equal to the time it takes to scan the FoV, would be achieved, which means introducing ambiguity in the speed estimation. As such, if desired to prioritize scanning of the FoV first, in addition to Doppler estimation, then effectively, an increased effective SRI is introduced, and some techniques to resolve the introduced ambiguity would be needed (because the SRI is not then determined based on the maximum detectable speed, but effectively defined based on what is needed to scan a full field of view first).

In order to resolve such ambiguity, it may be possible to introduce also a short but unambiguous signal measurement. On the other hand, depending on the underlying use-case, unambiguous speed estimation may not be critical, e.g., may be just comparing with a threshold or just detecting a movement can be enough for certain use-case.

In case resolving the unambiguity is essential (which may be true for many of the use-cases), a modified sensing signal structure for modified Doppler processing may provide a solution.

If the interval to scan a number of (with the number of OFDM symbols corresponding to the number of independent MIMO layers required to scan that beam) in the FoV is smaller than the SRI, then speed processing does not interfere with and increase FoV scanning time; still, the motivation for modifying Doppler processing may be to reduce the sensing overhead in each slot. Throughout this process, it may be the case where some ambiguous measurements are collected and the ambiguity is then resolved using some unambiguous measurements, but with an overall reduced overhead.

In one or more embodiments, one example of reducing sensing overhead and also resolving Doppler ambiguity may be related to one or both of [1] and [2]. Particularly, by more intelligent resource allocation, the signaling overhead can be reduced in comparison to the legacy time domain allocation, while the beam sweeping (scanning of FoV) can also be faster. To this end, [1] may describe that in TD, to introduce two radar excitation signals with two sets of SRI and k values: a 1st signal to provide unambiguous, but less accurate Doppler measurement, and a 2nd signal to provide accurate, but ambiguous Doppler measurement. For the first signal the SRI is configured for scanning a required velocity range up to the required maximum velocity, while the full sensing block duration, k*SRI, is smaller than required to meet the velocity resolution. For the second signal, the SRI is configured larger than required for scanning the required velocity range, while the sensing block duration k*SRI is as required to meet the velocity resolution. Further, while the second signal is sparse in time, but its SRI is short enough for scanning (at least) the velocity range given by the velocity resolution of the 1st signal. As such, since 2nd signal SRI is at most equal to the k*SRI of the 1st signal, if SRI of 1st signal is too short, 2nd signal will be too dense which would defeat the purpose of overhead reduction (this determines the limitation on the minimum SRI duration for the 1st signal).

In one or more embodiments, an additional factor that may be addressed when considering multiple full sensing block scans with differing number of doppler scans, k, is the requirement to maintain sufficient SNR. When performing a full sensing block scan, consisting of k sweeps, each doppler sweep contributes to SNR enhancement, not just in the doppler domain but also in the range domain. So, while it may not appear feasible to simply reduce the number of doppler scans, k in one particular beam direction, the SNR can actually be maintained for that beam scan, by a corresponding tradeoff of increased symbol repetition OS to achieve the desired SNR. Another alternative is increasing the beamwidth for cases when the number of doppler sweeps is reduced, which allows the total overall beam scan time for the FoV to be maintained and thus no degradation of SNR from the reduced number doppler scans, k. As a numerical example, consider subcarrier spacing (SCS) of 120 kHz, SRI of 7OS, k=32 doppler sweeps of the SRI, i.e., sensing block duration of 16 slots=2 ms, for a legacy sensing signal frame structure. In order to reduce the overhead and the scanning time, [1] may have embodiments that describe that, instead of the above, in TD, to introduce two radar excitation signals with two sets of SRI and k values, as follows:
A 1st signal with reduced burst duration (say 0.25 ms) but full TD spacing (7 OS), providing a coarse velocity resolution (77 km/h) but spanning entire velocity range (+154 km/h);
A 2nd signal with full burst duration (2 ms) but relaxed TD spacing (28 OS), providing full velocity resolution (9.6 km/h) but spanning a limited velocity range (=38 km/h).

The target velocity may then be computed by combining the results of the two measurements obtained with the two excitation signals.

Regarding the combining of the measurement results, the following may relate to a high-level interpretation of the Doppler estimation based on the technique related to [2] (while in [2] the described technique may be related to a FMCW radar waveform, the technique may not be tied to a specific waveform and here it is presented for the OFDM-based measurements). Suppose that two different and independent sets of velocity measurements are available, such that there are potential ambiguities in the first set of velocity measurement (ν_{amb}=l₁×Δν₁, where l₁ is the peak of the Doppler FFT for the first signal, and Δν₁ is the resolution of the first Doppler measurement), and no ambiguities in another set of velocity measurement (ν_{unamb,1}=l₂×Δν₂ where l₂ is the peak of the Doppler FFT for the second signal, and Δν₂ is the resolution of the second Doppler measurement) (which can be potentially of low estimation resolution/accuracy), and the maximum unambiguously measurable velocity is defined by

$${v}_{unamb , max} = \frac{{c}_{0} \times SCS}{2 \times {f}_{c}} .$$

Then, an updated unambiguous velocity (ν_{unamb,2}) can be obtained by adding a multiple integer q of ν_{unamb,max}, to ν_{amb},

ν_{unamb,2}=ν_{amb}+q×ν_{unamb,max},

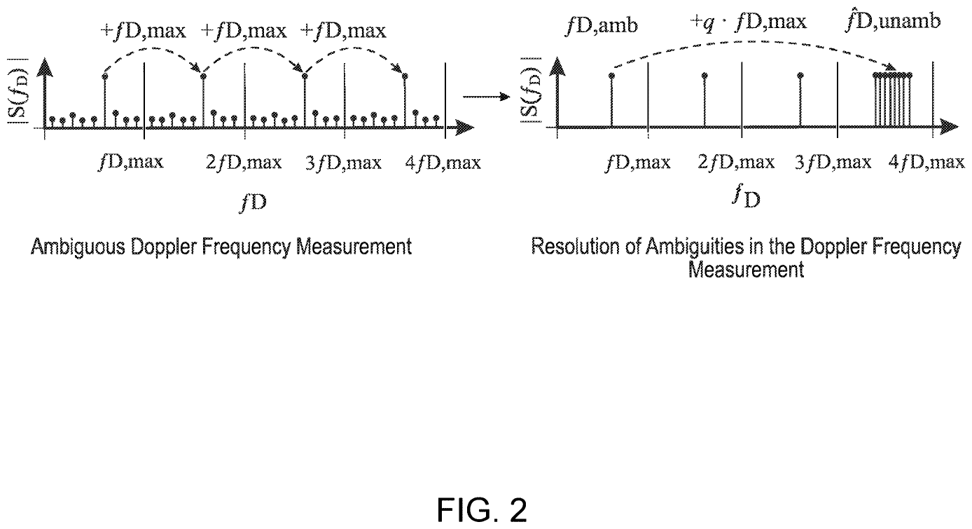

Such that q represents the ambiguity of Doppler frequency measurement. If q can be determined, the measured ambiguities may resolved (see, e.g., FIG. 2 (combining measurements to resolve ambiguity). q can be calculated by comparison of ν_{unamb,2} and the unambiguously but inaccurately measured velocity ν_{unamb,1}. From a signal processing point of view q is the nearest integer value to ν_{unamb,1}, obtained from ν_{unamb,2}, i.e.,

$$q = round \{ \frac{{v}_{unamb , 1} - {v}_{amb}}{{v}_{unamb , max}} \} .$$

This presents one example hierarchical way of getting into a desired resolution/accuracy. Particularly, rather than doing the fine (Nyquist) sampling throughout the entire sensing block, the core sampling within the ambiguity is done (more or less a wraparound version of the actual velocity), followed by looking around and fine tune in the identified region.

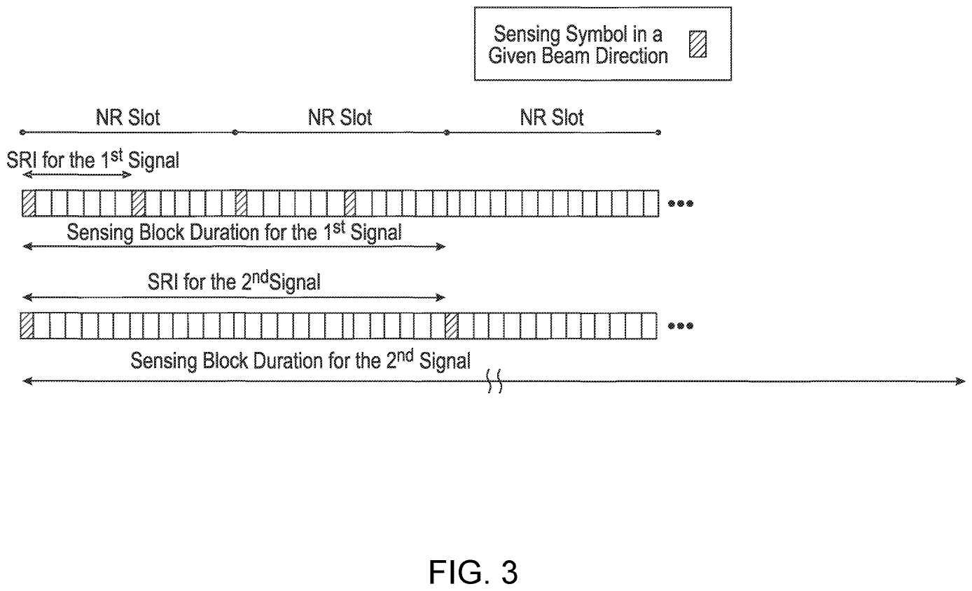

Accordingly, the signal structure can be presented as in FIG. 3, which depicts a two-signal structure for overhead and/or FOV scan time reduction (per beam)

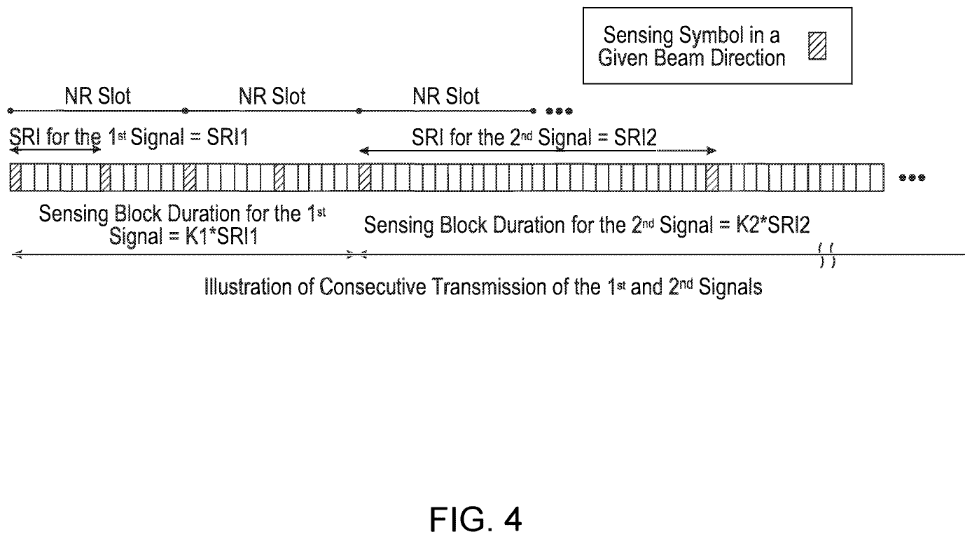

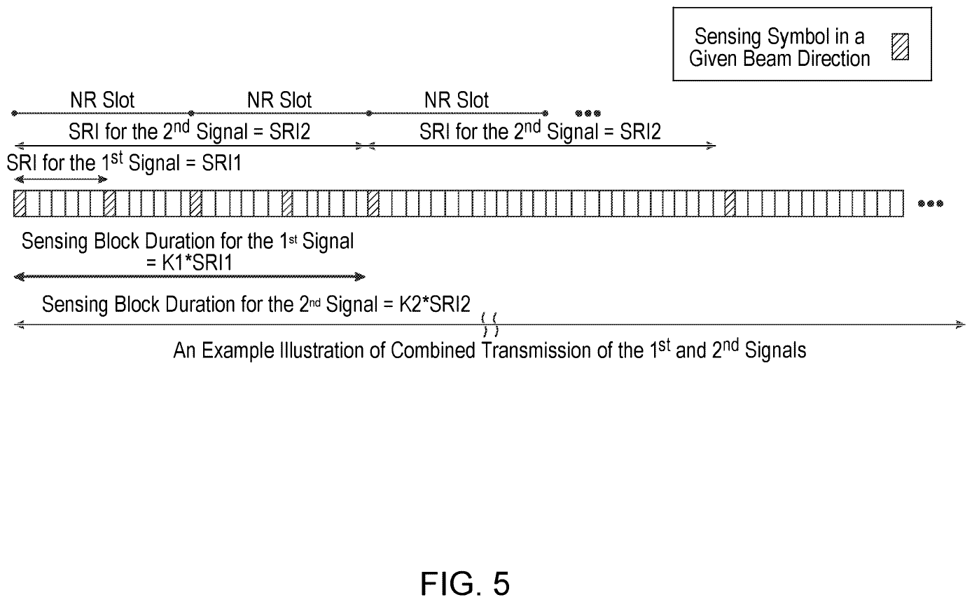

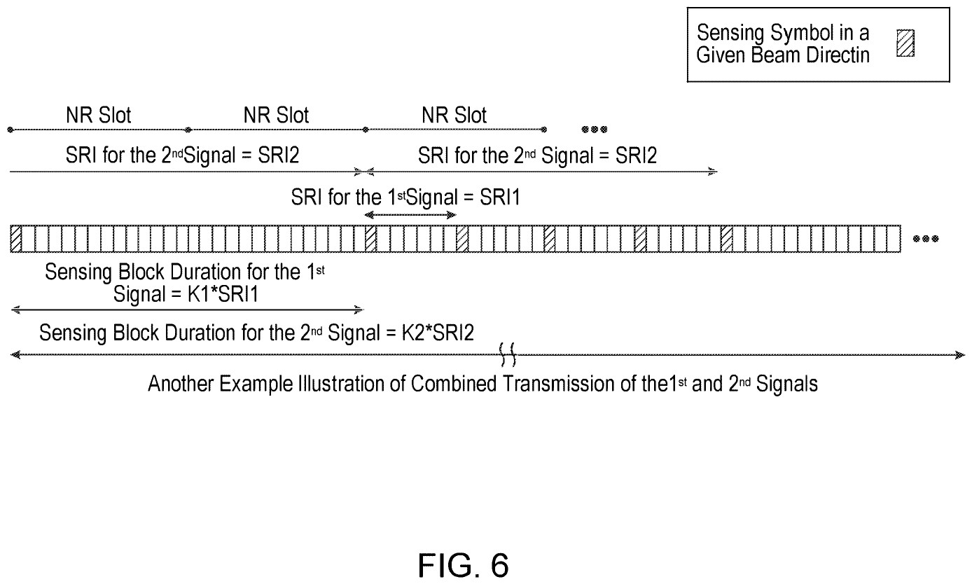

The two signals can be transmitted consecutively or simultaneously, meaning that the sensing block of the signals may or may not overlap (see, e.g., FIGS. 4, 5, and 6 (showing different relative placements of the sensing blocks of the two signals (per beam)). Different relative placements of the two signals' sensing blocks may or may not result in different combined measurement accuracy depending on the mobility of the targets in a given scenario. For example, if the velocity of a monitored target changes fast and frequently, it may be better that the two signals' sensing block overlap. Further, as illustrated in FIGS. 4, 5, and 6, the two signals may share certain symbol locations for a given beam direction.

Further, since during the two scans with the two signals the objects may move, and the movement may impact the velocity range of the fine estimation (the measurement over the longer period, where the estimation is performed with higher accuracy as well as a potentially lower maximum velocity range), transmission of overlapping between the two sensing blocks may be preferred (the velocity range of the signal transmitted over longer period needs to be able to capture not just the better accuracy for the first scan, but also potentially some movement of the objects).

In [1], some basic assessments of sensing signal resource overhead reduction as well as FoV scanning (beam sweep) time reduction (with fixed overhead for the sensing) may be described.

Regarding the sensing receiver complexity comparison between the legacy approach and the above two-signal-based approach, it is noted that the two-signal approach requires two periodograms (i.e., two slow-time FFTs) for every beam direction (e.g., Doppler FFT size for the 1st signal may be 16 and Doppler FFT size for the 2nd signal may be 64), while the legacy approach needs one larger periodogram (one slow-time FFT) for every direction (e.g., Doppler FFT size which is equal to the number of OFDM symbols across the sensing frame, may be 128).

In one or more embodiments, an enhanced resource management system may facilitate beam directions covered by the two bursts. It is noted that the above two-signal approach can be extended to each beam to cover the full FoV. On the other hand, in general, it is also possible to perform an initial scan (with a certain signal burst), followed by consecutive scan(s) where the beam coverage of the consecutive signals are fine-tuned based on the obtained information from earlier scans.

In one example, for the two-signal approach, when the bursts (sensing blocks) of the two signals are repeated based on certain update rates, the later occurrences of one or both of the signals (e.g., in terms of one or multiple aspects of the scanned FoV, the SRI, the sensing block duration) are fine-tuned based on initial bursts transmissions/receptions. Further, while the 1st and the 2nd signals may cover same set of beams to cover the FoV, it is possible that the beam order for the 1st and the 2nd signal are different.

Update-rates of the two signals: In order to better capture the high movements in the measurements, the update rate of the short dense signal may be higher than the update rate of the long sparse signal. It is noted that for each signal, if the update rate is equal to the sensing block, it means that the sensing block are transmitted back-to-back. The update rate of the short dense signal can be compared to the other signal's sensing block duration. For example, if the update rate of the short dense signal is smaller than the long signal's sensing block duration, it is possible that the short signal is transmitted multiple times within the duration of the long signal's sensing block. It may then be important to ensure the sensing signal configurations are capable of allowing such flexibilities.

Impact on DL-PRS and UL-PRS signal extensions: As mentioned, the feasibility of reusing DL-PRS and UL-PRS signals for sensing is described, along with the necessary extensions to enable such reuse. The feasibility of reusing DL-PRS and UL-PRS signal design, configuring them to allow for the technique of using two sensing signal bursts, e.g., with modified velocity measurements, for reduced overhead and FoV scan time, as well as the required extensions for such enablement, are disclosed. For example, the configuration of periodic/semi-periodic/aperiodic time-domain behavior, etc., for the two and the periodicities, etc., will be discussed.

The following is a discussion of DL-PRS resource set configuration showing an example list of parameters to be configured for a DL-PRS resource (although more, fewer, or different parameters may be used in different embodiments):
1. A DL-PRS Resource ID, defining particular DL-PRS Resource. A DLPRS Resource ID in a DL-PRS Resource Set is associated with a single spatial TX filter (beam) & is transmitted from a single TRP (see also below).
2. A DL-PRS Sequence Identity, defining initialization seed for the pseudorandom Gold sequence generator for DL-PRS Resource.
3. A DL-PRS Comb Size N, defining RE spacing in frequency domain for each symbol of DL-PRS Resource. N can take the values {2, 4, 6, 12}.
4. A DL-PRS RE Offset, defining RE offset in frequency domain for 1st symbol in DL-PRS Resource. Relative RE offsets of following symbols are defined relative to RE offset of 1st symbol in DL-PRS Resource
5. A DL-PRS-Resource Slot Offset, defining starting slot of DL-PRS Resource with respect to corresponding DL-PRS-Resource Set Slot Offset
6. A DL-PRS Resource Symbol Offset with values {0, 1, 2, . . . , 12} defining starting symbol of DL-PRS Resource within a slot determined by DL-PRS Resource Slot Offset.
7. A DL-PRS Number of Symbols, defining the number of symbols per DL-PRS Resource within a slot. Values of {2, 4, 6, 12} are defined. It is noted that each PRS resource is configured with one beam, and it is not possible to have one symbol in one PRS resource with one beam and another symbol with another beam.
8. A DL-PRS Subcarrier Spacing, defining the Subcarrier Spacing for the DL-PRS Resource (15, 30, 60 kHz for FR1; and 60, 120 kHz for FR2)
9. A DL-PRS Cyclic Prefix, defining CP length of DL-PRS Resource (normal or extended)
10. A DL-PRS Point A, defining the absolute frequency of the reference resource block for DL-PRS. Its lowest subcarrier is named “DL-PRS Point A”.
11. A DL-PRS-Start PRB, defining the start PRB index as an offset from DL-PRS Point A, in multiples of 1 PRB
12. A DL-PRS Resource BW, defining #PRBs allocated for the DL-PRS Resource (allocated DL-PRS bandwidth), in multiples of 4 PRBs
13. A DL-PRS Quasi-Colocation Information, providing QCL info between DL-PRS and other reference signals.

The following is an example list of parameters to be configured for a DL-PRS resource set (although embodiments may use more, fewer, or different parameters):
1. A DL-PRS Resource Set Identity, which defines an identity of the DL-PRS resource set configuration
2. A DL-PRS Periodicity, which defines the DL-PRS Resource's (more accurately, resource set's) periodicity in the number of slots. Periodicity depends on SCS and can take values of 2μ {4, 5, 8, 10, 16, 20, 32, 40, 64, 80, 160, 320, 640, 1280, 2560, 5120, 10,240} slots, with μ=0, 1, 2, 3 for SCS 15, 30, 60 and 120 kHz, respectively. All the DL-PRS Resources within one resource set have the same periodicity.
3. A DL-PRS Resource Repetition Factor, which defines how many times each DL PRS Resource is repeated for a single instance of the DL-PRS Resource Set. Values of {1, 2, 4, 6, 8, 16, 32} are supported. All DL-PRS resources within one resource set have same Resource Repetition Factor.
4. A DL-PRS Resource Time Gap, which defines the offset in #slots between two repeated instances of a DL-PRS Resource with the same DL-PRS Resource ID within a single instance of the DL-PRS Resource Set. Values of {1, 2, 4, 8, 16, 32} are supported.
5. A DL-PRS Muting Pattern, which defines a bit map of the time locations where the DL-PRS resource is transmitted or not for a DL-PRS Resource Set. The bit map size can be {2, 4, 8, 16, 32} bits long.
6. A DL-PRS Muting-Bit Repetition Factor, which defines the number of consecutive instances of a DL-PRS Resource Set corresponding to single bit of the DL-PRS Muting Pattern for Option 1 muting.
7. A DL-PRS Resource Set Slot Offset, which defines the slot offset with respect to SFN #0/slot #0 of the TRP, i.e., defines the slot where the first DL-PRS Resource of the DL-PRS Resource Set occurs,
8. The DL-PRS Resource list, defining the configuration for each resource in the set, as described above.

The mapping of DL-PRS attributes to sensing signal desired attributes may be an area of focus. One example of this could be as follows:
1. Resource set↔sensing block: possible durations for PRS resource set, is based on repetition parameters and the number of resources within the set, e.g., may be from one slot (if repetition factor is 1) to multiple slots.
2 The number of PRS resources within a PRS resource set↔the number of beam directions in SRI: This also determines the time gap for the repetition, to support multiple direction in SRI, and is also related to the number of OFDM symbols [symbol pairs—since the minimum duration of a PRS resource is currently 2 OFDM symbols] within SRI. Each PRS resource is mainly dedicated to one direction, as each PRS resource corresponds to a beam from one TRP.
3. SRI↔collection of one occurrence of all PRS resources within the set. For sensing, each symbol within SRI can be allocated to a different beam/direction. Also, in a PRS resource set, multiple PRS resources, each for one direction is transmitted.
4 Repetition factor for PRS resource repetition within one instance of resource set↔Doppler FFT size, k
5. Periodicity of resource set↔update rate for sensing.

Parameters 2-6 regarding DL-PRS resource set configuration, together with parameters 3, 6, and 7 regarding DL-PRS resource configuration, can determine the time domain pattern for DL-PRS. As such, considering the above analogies, with certain configuration of PRS resources and PRS resource set, e.g., time gap and the repetition factor, the repetitive pattern can be configured to meet the sensing needs.

For one-direction sensing, one PRS resource, i.e., one beam direction, and repetitions of that resource for Doppler estimation is required. For PRS-based sensing, it is important to understand how frequent the occurrence of one direction can be for Doppler processing, proper PRS configurations, and with what granularity time/frequency resources for that direction can be configured.

A look into slot-level supported patterns of PRS resources, shows that within a slot, there can exist one or multiple PRS resources (of one or multiple resource sets), each with or without intra-slot-level repetition. For example, it is possible that multiple PRS resources, e.g., each of length 2 OS, are Time-Domain-Multiplexed (TDMed) within one resource set of length one slot.

While repetition of the PRS resources occurs across slots, within the resource, also repetition of a beam is allowed, this may be mainly used for processing gain (not Doppler estimation).

Regarding SRI duration of integer multiples of slot (minimum of one-slot SRI duration), depending on the time gap being set for the PRS repetition, different SRI durations can be defined. For example, with a repetition time gap of 1 slot, and all PRS resources of the set also packed next to each other within a slot, e.g., each PRS resource is 2-12 OFDM symbols, an SRI duration of one slot can be achieved. With a time gap of 2 slots, and all PRS resources of the set are also packed next to each other within a slot, an SRI of 2 slots can be achieved wherein only within the first slot of the SRI, the sensing transmission takes places. The same logic applies for larger time gaps, leading to lower Doppler/speed detection. Essentially, the resulting PRS resource set duration, i.e., equivalent of sensing frame duration, would be equal to (repetition factor)*(time gap). For sub-slot level SRI duration, special handling and extensions would be required.

For multi-directional sensing, multiple PRS resources, i.e., multiple beam directions, and repetitions of those resource for Doppler estimation is required. Depending on how different resources of a single or multiple resource sets are located, SRI can be defined differently. Even though sub-slot-level SRI may be also made possible with PRS, the structure of PRS allows for limited number of directions to be covered within one SRI and certain extensions for DL-PRS are required to enable more flexibility. For SRI durations of integer multiples of slots, similar to the one-directional sensing case, if multiple PRS resources of the same resource set are TDMed within one slot, and if all resources of a set fit in a slot, the minimum SRI duration of one slot would be achieved. Depending also on the time gap set for the repetition, different SRI durations can be defined. Further, if a PRS resource set contains resources over multiple slots, either one slot per resource, or mix of slots with single and multiple resources, SRIs over multiple slots can be also defined, effectively for lower Doppler estimations.

In one or more embodiments, an enhanced resource management system may facilitate extensions to DL-PRS to enable two-signal approach.

As a DL-PRS resource set is mapped to a sensing block, in one example, the two-signal approach is enabled using two DL-PRS resource sets, each providing the sensing block corresponding to one of the two signals. In order to realize overlapping OFDM symbols carrying transmission in the same beam directions in both sets (e.g., in the combined transmission of the two signals) (FIGS. 4, 5, and 6), for the short dense signal, it is possible to not to account for the boundary symbols and allow the other set to accommodate those symbols. Alternatively, a frequency comb structure can be used between the two sets over the same symbols. Depending on whether the two sets need to cover the same beam directions, the DL-PRS resources within the two sets can be configured accordingly.

At the same time, it is noticed that the above approach results in doubled RRC signaling overhead for the configuration of the two sets and the corresponding resources. Accordingly, in another example, the combined two-signal is configured with one set of configurations for the set, but with two sets of values configured for the repetition gap and repetition factor, and a parameter indicating the relative offset between the starting of the two sets. As such, every beam direction (DL-PRS resource) is transmitted accordingly to the repetition pattern of the long sparse set, except during the time span indicated by these parameters wherein it will be transmitted according to the pattern of the short dense set.

In one example, QCL relations are defined between the first and the second signals, e.g., to identify DL-PRS resources (beams) used for the first and second scans for the two-signal approach.

Further, to enable half-slot SRI duration, some extra handling/extensions are required. In one example, the extended DL-PRS configurations allow DL-PRS repetition gap in granularity of half-slot, where the repetition factor counts the number of half-slots that it repeats. In another example, the extended DL-PRS configurations allow the DL-PRS set to span over first half of a slot and allows for configuring a repetition gap of zero (e.g., in number of half-slots). These extensions help realizing the two-signal approach, as well as the legacy approach when SRI of half slot is needed.

The following is an example list of parameters describing an UL-PRS resource (although other embodiments may use more, fewer, or different parameters):
UL-PRS Resource Identity (SRS-PosResourceId): defining the particular UL-PRS Resource.
Transmission Comb: defining:
   comb size N of UL-PRS (N=2, 4 or 8),
   comb offset of the first symbol of UL-PRS Resource (0 . . . . N−1),
   cyclic shift for generating the reference sequence, e.g., Comb 2 supports 8 cyclic shifts and Comb 4 supports 12 cyclic shifts.
Resource Mapping: defining 1st OFDM symbol location of UL-PRS Resource in a slot (0, 1, 2, . . . , 13) and the number of symbols of UL-PRS Resource (1, 2, 4, 8 or 12).
Frequency Domain Shift: defining frequency domain position of UL-PRS Resource (same as for Rel-15 SRS).
Frequency Hopping: defining bandwidth of UL-PRS Resource. The name is reused from Rel-15 SRS, although frequency hopping for UL-PRS is not supported. However, part of the frequency hopping parameter is BW indication, which is the only parameter applicable for UL-PRS.
Group or Sequence Hopping: defining whether group or sequence of hopping is used (same as for Rel-15 SRS). The hopping modes are used to randomize the reuse of a sequence in the system.
Resource Type: defining UL-PRS Resource type (periodic, semi-pers, aperiodic) & periodicity for semi-persistent & periodic UL-PRS.
Sequence ID, defining a UE specific sequence ID used to initialize PN group and sequence hopping. For UL-PRS, #different sequence group hopping pattern is increased from 1024 (Rel-15 SRS) to 65536, and number of bits for sequence ID is increased to 16. For UL-PRS to be received by neighboring TRPs, increasing available #UL-PRS sequences can be beneficial for reducing UL-PRS collision & further mitigating UL interference.
Spatial Relation Info: defining the spatial relation between a reference RS and the target UL-PRS. The reference RS can be an SSB, CSI-RS (for serving cell only), DL-PRS, SRS or UL-PRS.

The following is the list of parameters describing an UL-PRS resource set:
UL-PRS Resource Set Identity (SRS-PosResourceSetId in the specification): defining particular UL-PRS Resource Set. It is unique in the context of the BWP in which the UL-PRS is defined.
Resource Type: defining time domain behavior of UL-PRS resource configuration. The network configures UL-PRS Resources in the same Resource Set with the same time domain behavior on periodic, aperiodic & semi-persistent. This means that the periodicity values are configured for the set, and different resources within the set cannot have different periodicities. A UE is not expected to be configured with SRS resources in the same SRS resource set SRS-ResourceSet or SRS-PosResourceSet-r16 with different slot level periodicities. For periodic SRS, for how long the SRS is transmitted with those periodicities, is up to the network configuration, and the periodic transmission continues unless reconfigured (as long as UE is in that particular state unless reconfigured by RRC, being it inactive or connected, the UE will be able to transmit).
Alpha a value for the UL-PRS power control: defining the fractional pathloss compensation. The alpha value is multiplied by the UE with the pathloss estimate. For full pathloss compensation, alpha is equal to 1.
p0 a value for the UL-PRS power control which can be described as the “desired receive power” at the TRP. That is, the UL-PRS Tx power determination is based on p0+alpha·PL, where PL is the pathloss estimate.
Pathloss Reference RS: defining the reference DL signal to be used for pathloss estimation. The DL reference signal can be an SSB or DL-PRS from the serving or neighboring TRP.
UL-PRS Resource list: defining the configuration for each resource in the set.

The mapping of UL-PRS attributes to sensing signal desired attributes is a relevant topic. One example of this mapping process may be as follows:
UL-PRS resource↔sensing beam (for UL-based positioning, single port UL-PRS resource is supported, i.e., each UL-PRS resource is dedicated for transmission in a single direction). A resource corresponds to an SRS beam, and resource sets correspond to a collection of SRS resource (i.e., beams) aimed at a given TRP.
The number of PRS resources within a PRS resource set↔the number of beam directions in SRI. This is also related to the number of OFDM symbols in each SRS resource of the set and how they are located.
Resource set together with periodicity/repetition parameters and the number and distancing of resources within the set, define SRI↔SRI (collection of one occurrence of all PRS resources within the set). As mentioned above, for sensing, each symbol within SRI can be allocated to a different beam/direction and in an SRS resource set, multiple SRS resources, each for one direction is transmitted. Currently, there may be no restriction on the min/max duration of a set (one instance of the set) in time domain, and the duration and placement of the resources within a set are a matter of configuration.
The entire time interval which contains repetitions of resource set with its periodicity (i.e., repetitions of SRI)↔sensing block—possible durations is based on network configuration.
Number of repetitions of SRS resource set↔Doppler FFT size, k

How frequent periodic occurrence is (re-)configured↔update rate for sensing (the minimum achievable update rate may be related to the signaling limitations)
For one-direction sensing, one UL-PRS resource, i.e., one beam direction, and repetitions of that resource for Doppler estimation are required. For UL-PRS-based sensing, it is important to understand that with proper UL-PRS configurations, how frequent the occurrence of one direction can be for Doppler processing, and with what granularity time/frequency resources for that direction, can be configured.

A look into slot-level supported patterns of UL-PRS resources, shows that within a slot, there can exist one or multiple UL-PRS resources (of one or multiple resource sets), each with or without intra-resource-level repetition. For example, it is possible that multiple UL-PRS resources, e.g., each of length 2 OS, are TDMed within one resource set of length one slot.

While repetition of the UL-PRS resource sets occurs across slots, within the resource, also repetition of a beam is allowed, this may be mainly used for processing gain (not Doppler estimation).

With UL-PRS-based sensing, SRIs durations of integer number of slots can be achieved straightforwardly, since the minimum periodicity of one slot is supported. However, for SRI duration of half-slot, some special handling and extensions are needed as disclosed. This involves specific adaptations to accommodate the unique requirements of a half-slot SRI duration, ensuring efficient and effective signal processing.

Regarding SRI duration of integer multiples of slot (minimum of one-slot SRI duration), depending on the periodicity, and the number of resources within the set, different SRI durations can be defined.

For multi-directional sensing, multiple UL-PRS resources, i.e., multiple beam directions, and repetitions of those resources for Doppler estimation are required. Within the resource, repetition of each beam is mainly for processing gain within the SRI, not for Doppler estimation. Depending on how different resources of a single or multiple resource sets are located, SRI can be defined differently. For SRI durations of integer multiples of slots, similar to the one-directional sensing case, if multiple PRS resources of the same resource set are TDMed within one slot, and if all resources of a set fit in a slot, the minimum SRI duration of one slot would be achieved. Depending also on the periodicity set for the set, different SRI durations can be defined. Further, if an SRS resource set contains resources over multiple slots, either one slot per resource, or mix of slots with single and multiple resources, SRIs over multiple slots can be also defined, effectively for lower Doppler estimations.

In one or more embodiments, an enhanced resource management system may facilitate extensions to UL-PRS to enable two-signal approach. As a whole burst of periodic occurrences of an UL-PRS resource set is mapped to a sensing block, in one example, the two-signal approach is enabled using two UL-PRS resource sets with their respective periodic occurrences, each providing the sensing block corresponding to one of the two signals. In order to realize overlapping OFDM symbols carrying transmission in the same beam directions in both sets (FIGS. 4, 5, and 6), for the short dense signal, it is possible to not to account for the boundary symbols and allow the other set to accommodate those symbols. Alternatively, the frequency comb structure can be used between the two sets over the same symbols. Depending on whether the two sets need to cover the same beam directions, the UL-PRS resources within the two sets can be configured accordingly.

At the same time, it is noticed that the above approach may result in doubled RRC signaling overhead for the configuration of the two sets and the corresponding resources. Accordingly, in another example, the combined two-signals are configured with one set of configurations for the set, but with two values configured for the periodicity, and a parameter indicating the relative offset between the starting of the two periodicities (e.g., how much earlier or later one periodicity may start using positive and/or negative values, which can be defined in granularity of OFDM symbol, or half-slot, etc.). Currently, UL-PRS configuration parameters do not indicate for how long the periodic occurrences of UL-PRS resource sets continue, and one of the extensions contains inclusion of such indication. Assuming one can build upon such design, in one example, one set of configurations for the set, but with two sets of values configured for the periodicity and the duration parameter, and a parameter indicating the relative offset between the starting of the two periodicities, can be considered. As such, every beam direction (UL-PRS resource) is transmitted accordingly to the periodicity of the long sparse set, except during the time span indicated by these parameters wherein it will be transmitted according to the pattern of the short dense set.

In [1], the two-signal technique may only intend to achieve an angle resolution equal to the beamwidth of the sensing signal. Particularly, for the radio base station being equipped with an antenna array, the covered cell is to be scanned by means of a beam sweep, and the beam width determines the angle resolution (i.e., mmWave system with full analogue (or digitally controlled analogue) beamforming). As such, the complex data generated at the outputs of the 2D FFT (periodogram) for the two signals, may not be fed into a high-resolution angular processing algorithms (such as MUSIC, ESPIRIT, etc.) (and rely on beam sweeping only AoA techniques).

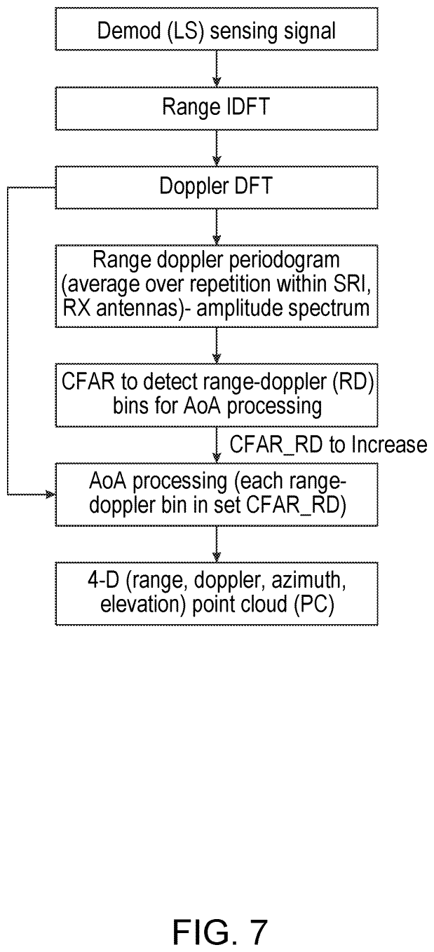

On the other hand, cellular technology is moving in the direction to enable digital beamforming even for mmWave in future. Further, this technique may still be used for FR1 where digital beamforming is available (e.g., to get the benefit of lower sensing overhead). As such, one needs to work out the input to the angular processing algorithms. In the legacy technique, the complex data at the output of the Delay-Doppler periodogram which forms a 2D map, following a constant false alarm rate (CFAR) detection, is fed into the AoA estimation algorithms as shown in FIG. 7; however, with the two-signal velocity estimation approach, two periodograms are generated, each for one signal, and combining (at least coherently) the two complex data sets to form a unified 2D map may not be possible. FIG. 7 shows a sensing signal processing flow.

In one example, the two sets of complex data are processed separately for angle of arrival, e.g., to obtain two sets of angle-of-arrival estimations. In one example, the two AoA estimations can be combined via a weighted sum or the maximum ratio combining (MRC), or in a similar way that the two sets of velocity estimates are combined (described above), or any other technique.

In one or more embodiments, an enhanced resource management system may facilitate control signaling to support sensing needs/flexibilities (for dynamic FoV scan rate, etc.). A goal in a JCAS system is to enable positioning and sensing with the same signal as much as possible. At the same time, it is noted that for the case of DL-PRS-based positioning, the UE is the receiver, and for the case of monostatic sensing based on DL-PRS, the BS is the receiver, each with different set of objectives.

In some embodiments, a higher number of repetition factor may be needed for sensing applications and the DL-PRS configuration should be extended to support larger numbers. On the other, for positioning at the UE, based on DL-PRS signaling, such extension may not be needed, and the UE may not desire to use the extended number of repetitions, e.g., to save its power, compute complexity, etc. As such it is beneficial to allow for smaller number of repetitions for positioning application while supporting larger number of repetitions for sensing. Particularly, when the BS transmits the DL-PRS according to the number of repetitions require for the sensing application, the UEs may not necessarily measure over all the repetitions for positioning.

In one example, the BS can configure two values for the repetition factor (e.g., one value indicating the maximum value required for sensing, and the other the value configured for positioning), and the UE can perform measurement based on the smaller value if it intends to. In one example, UE can decide on a number of repetitions based on the indicated minimum and maximum values, and perform the measurements accordingly. The UE may indicate the assumed number in an UL control transmission. In another example, the UE may transmit termination indication, to indicate to the gNB the instance it stops processing the repetitions.

For DL-PRS, all the signal configurations and parameters, are indicated through RRC signaling, and can be reconfigured as frequent as the typical RRC reconfiguration allows, e.g., order of 100s of milliseconds, which can be much higher that the time needed for a single full FoV scan. For sensing, there may need to add more flexibility in terms of configurations/re-configurations, e.g., to allow for dynamically adapted bursts of signals, based on FoV characteristics, objects mobility, etc.

As mentioned above, parameters 2-6 regarding DL-PRS resource set configuration, together with parameters 3, 6, and 7 regarding DL-PRS resource configuration, can determine the time domain pattern for DL-PRS. As such, with certain configuration of PRS resources and PRS resource set, e.g., time gap and the repetition factor, the repetitive pattern can be configured to meet the sensing needs. In one example, one or multiple of the aforementioned parameters (and/or one or multiple of the associated extended configurations) are configured through DCI indication or MAC CE to allow for more flexibility in reconfiguration and lower signaling latency compared to RRC configuration.

In another example, while the initial configuration of DL-PRS can still be indicated by RRC, one or multiple of DL-PRS resource and DL-PRS resource set configuration parameters can be overridden by DCI or MAC CE indications, at any time, e.g., including the time and frequency pattern, periodicity, triggering, and stopping.

In general, for sensing scenarios where parameters of upcoming scans are adjusted/configured based on initial/earlier scan(s), some (re)configuration of the DL-PRS resources is necessary to adjust the beams/resources, etc., after the initial scan or after each scan, for the next ones. As such, frequent RRC reconfiguration may be needed which is not desired, e.g., due to latency inefficiency, etc. Accordingly, more flexible lower-latency signaling tools such as DCI indication are preferred. In summary, after the initial scan(s), consequent scans may still be based on predetermined KPIs and hence, have predetermined resource needs, or may be adjusted based on earlier scan(s) and have dynamic resource needs (due to beam/FoV adjustments and/or velocity/range changes). However, the current positioning signals configurations do not support the dynamicity and flexibility required in the latter.

Further, for sensing it may be desired (e.g., depending on the use-case and its requirements) to gather a full scan of FoV, e.g., within a short time, and then wait for a longer period of time before starting another scan. This may allow for the high velocity detection without blurring. In some use-case scenarios, it is desired that once per slow update-rate, a snapshot of full FoV or the part of FoV over which objects' mobility is high, is taken at the fastest rate (e.g., with shorter SRIs to detect high speeds and potentially shorter sensing block duration), to provide optimal coverage of any fast-moving objects. At other times, the scanning can be performed at a slower rate (e.g., with larger SRIs) when no fast-moving objects are expected (anywhere in the FoV or over the part of the FoV with low/no-mobility objects). Accordingly, DL-PRS configuration needs to allow for multiple levels of scan rate configurations (to allow multiple/different repetition patterns and update rates), to enable a fast scan rate for rapidly gathering a number of DL-PRS resources, followed by a slower scan rate to enable a waiting period for dedicated communications before the next rapid period. For DL-PRS, since the update rate is based on the DL-PRS resource set periodicity, to allow for more flexible/dynamic configuration of update rate, in one example, the set periodicity can be indicated via MAC CE or DCI (as opposed to the current RRC-based indication). This provides more flexibility to adjust the scans based on FoV characteristics.

Further, it is possible to make the repetitive occurrence of a scan set over a certain configured duration, and be repeated irregularly based on some indications/triggers (e.g., instead of always being based on the set's periodicity).

Similar to DL-PRS, NR UL-PRS may have certain level of flexibility for beamforming and spatial allocation. For example, within an SRS resource set, there is flexibility for spatial allocations. Particularly, there can be different resources (beams) within a set. The current SRS design enables the possibility to repeat some directions more often than others. Even though all resources of a set repeat by the same periodicity, but within a resource, (e.g., for comb-2/2-OS), 1 or 2 or 4 or 6 repetitions can take place, which provides additional flexibility.

Further, multiple SRS resource sets may be configured to a UE, which may allow different beamforming across the different sets. For instance, a set of narrow beams to cover a region that is mapped to one set, and another set of wider beams to target a slightly different coverage that can be mapped to the second resource set. In the context of sensing, this design aspect may also have application in realizing sub-slot-level SRI durations, as will be disclosed later. Further, this concept may be reused to define multiple sensing frames (together with their corresponding SRI settings) (e.g., to benefit from different measurements and/or different levels of dynamicity in different parts of the environment/FoV). At the same time, it is noted that if any parameter in the configuration of a later scan depends on the earlier scans/measurements, then proper means to support this level of dynamicity is required, since currently, in NR, all such configuration is based on RRC signaling which has certain limitations.

For UL-PRS, some similar extensions as mentioned above for DL-PRS, in order to increase the flexibility of periodic configurations, are also applicable. These extensions enhance the versatility of setting up periodic arrangements for UL-PRS, mirroring the advancements made in the context of DL-PRS.

Further, as mentioned above, for sensing it may be desired, depending on the use-case and its requirements, to gather a full scan of the FoV within a short time and then wait for a longer period before starting another scan. Embodiments relate to extensions of UL-PRS configuration to allow for multiple levels of scan rate configurations. This enables multiple/different repetition patterns and update rates, facilitating a fast scan rate for rapidly gathering a number of UL-PRS resources. Subsequently, a slower scan rate is employed to enable a waiting period for dedicated communications before the next rapid period.

In order to allow dynamic FoV scans based on previous snapshots, and adapt the SRIs corresponding to each beam direction for each snapshot, some UE indication on the preferred parameters corresponding to the repetitive pattern of the signal may be desired.

In one example, e.g., after initial FoV scan(s) based on the RRC-configured parameters for UL-PRS, for UE monostatic sensing scenarios, the UE can indicate the required periodicity(ies), the required overall interval over which the periodic occurrences happen, and/or the potential directions to be scanned. The gNB can then configure the UL-PRS accordingly. Such configuration may be based on RRC signaling, MAC CE, or preferably based on DCI indication which has a higher level of dynamicity compared to the other two signaling techniques.

In one example, one or multiple of the UL-PRS resource and resource set configuration parameters (and/or one or multiple of the associated extended configurations) are configured through DCI indication or MAC CE. This allows for more flexibility in reconfiguration and lower signaling latency compared to RRC configuration.

In another example, while the initial configuration of UL-PRS can still be indicated by RRC, one or multiple of UL-PRS resource and UL-PRS resource set configuration parameters can be overridden by DCI or MAC CE indications, at any time, e.g., including the time and frequency pattern, periodicity, triggering, and stopping.

In general, for sensing scenarios where parameters of upcoming scans are adjusted/configured based on initial/earlier scan(s), some (re)config of the UL-PRS resources is necessary to adjust the beams/resources, etc. after initial scan or after each scan, for the next ones. As such, frequent RRC reconfiguration may be needed which is not desired, e.g., due to latency inefficiency, etc. Accordingly, more flexible lower-latency signaling tools such as DCI indication are preferred. In summary, after the initial scan(s), consequent scans may still be based on predetermined KPIs and hence, have predetermined resource needs, or may be adjusted based on earlier scan(s) and have dynamic resource needs (due to beam/FoV adjustments and/or velocity/range changes). However, the current positioning signals configurations do not support the dynamicity and flexibility required in the latter.

The following is a discussion of Spatial relations. In NR, both DL-PRS and UL-PRS can also serve as spatial QCL references to establish positioning beam pairs. That is, given the knowledge of a suitable RX beam for DL-PRS, RX knows that the same RX beam should be suitable for UL-PRS. Spatial relation indication for UL-PRS Resources is supported, either to a DL RS (SSB, CSI-RS (for serving cell only) or DL-PRS) or UE's previously transmitted SRS or UL-PRS. UL-PRS beam may be derived from the spatial relation to an indicated DL RS, whereupon UE may transmit UL-PRS in the reciprocal direction to how it set its RX beam when receiving the DL RS, as illustrated. An additional procedure may be used by the network, where the UE transmits an UL-PRS or SRS beam sweep and the gNB refers back to one of the swept beams in a previously transmitted UL-PRS or SRS resource to indicate spatial relation to UL-PRS resource.

In one example, QCL relations are defined between DL-PRS resources (beams) used for different/consecutive FoV scans. In another example, QCL relations are defined between UL-PRS resources (beams) used for different/consecutive FoV scans.

In one or more embodiments, an enhanced resource management system may may facilitate sensing overhead reduction by allowing reuse of sensing physical resources (multiplexing in delay (or Doppler) domain).

Since an idea to be disclosed here relies on enabling resource reuse for sensing signals, e.g., by use of the cyclic shift concept, in the following subsections, some discussion on current application of this concept in NR specification is provided. While the discussion may introduce this concept in the context of UL-PRS, the disclosed technique in a later section, is not limited to sensing based on UL-PRS and is applicable to both DL-PRS and UL-PRS.

The following is a discussion of SRS Sequences. Sequences applied to the set of SRS REs are partly based on Zadoff-Chu (ZC) sequences. Although ZC sequences of prime length are preferred in order to maximize the number of available sequences, SRS sequences are not of prime length. SRS sequences are extended ZC sequences based on the longest prime-length ZC sequence with a length M smaller or equal to the desired SRS sequence length. The sequence is then cyclically extended in frequency domain (FD) up to the desired SRS-sequence length. As the extension is done in frequency domain, extended sequence still has constant spectrum, and thus “perfect” cyclic autocorrelation, but time domain amplitude will vary somewhat. Extended ZC sequences used as SRS sequences are for sequence lengths of 36 or larger, corresponding to an SRS extending over 6 and 12 resource blocks in case of comb-2 and comb-4, respectively.

Due to their specific properties, ZC sequences are used at several places within the NR specifications, especially in the uplink transmission direction. A ZC sequence has a characterizing parameter u, referred to as the root index of the ZC sequence. For a given sequence length M, #root indices generating unique ZC sequences equals the number of integers that are relative prime to M. For this reason, ZC sequences of prime length are of special interest as they maximize the available Zadoff-Chu sequences. More specifically, assuming the sequence length M being a prime number there are M−1 unique ZC sequences. A key property of ZC sequences is that the discrete Fourier transform of a ZC sequence is also a ZC sequence. A ZC sequence has constant time-domain amplitude making it good from a power-amplifier-efficiency point of view. As Fourier transform of a ZC sequence is also an ZC sequence, there would then also be constant power in FD, that is, in addition to constant time domain (TD) amplitude, ZC sequences also have flat spectra. As a flat spectrum is equivalent to zero cyclic autocorrelation for any non-zero cyclic shift (CS), this implies that two different TD cyclic shifts of the same ZC sequence are orthogonal to each other. A cyclic shift in TD corresponds to applying a continuous phase rotation in FD.

The following is a discussion of randomizing between users. To randomize SRS interference between users transmitting SRS within the same bandwidth, in the same cell and in different cells, a time-dependent sequence randomization (sequence hopping) can be configured for SRS sequence. The sequence used for SRS depends pseudo-randomly on both slot index and symbol index within a slot. In addition, the used SRS sequence initialization is UE-specifically configured by RRC.

The following is a discussion of UE multiplexing. SRS is also designed with a comb-based pattern similar to DL-PRS. SRS transmissions from different UEs can be Frequency Domain Multiplexed (FDMed), within the same frequency range by assigning different combs, corresponding to different frequency offsets (comb phases). UEs can be multiplexed over the same transmitting symbol by assigning different comb patterns. For comb-2, for example, two SRS comb phases can be FDMed, with each comb phase supporting up to 8 TD cyclic shifts. In the case of comb-4, four SRS comb phases can be FDMed with each comb phase supporting up to 12 TD cyclic shifts. Multiple SRS ports (i.e., 1001~1003) can also be interleaved in frequency domain within the same OFDM symbol (more information regarding the port multiplexing is provided in the following subsection).

The following is a discussion of SRS ports multiplexing. An SRS resource can be configured to 1, 2, or 4 SRS ports. When an SRS resource is mapped to more than one OFDM symbol, each SRS port of SRS resource is present in every symbol and across whole configured SRS bandwidth of resource, i.e., all SRS ports are present in each OFDM symbol of the resource (different ports share same set of resource elements (REs) and same basic SRS sequence). An SRS antenna port can thus be repeatedly transmitted by UE in 2 or 4 symbols in a slot, which can be used to extend SRS coverage. Different configuration alternatives allow the mapping of ports of SRS resource to subcarriers in an OFDM symbol using either a comb-4 or a comb-2 structure. An SRS port transmission is mapped to every 2nd to 4th subcarrier in OFDM symbol (i.e., a comb structure is used) for comb-2 and comb-4 respectively. This means that comb structure can be used for FDM of multiple UEs as well as FDM of multiple ports of a PRS resource. For example, gNB can configure a 2-port UE over one comb-2 REs, and FDM another 1-port or 2-port UE over the other comb-2 REs, over same OFDM symbol, where each UE's multi-port transmission is separated using cyclic shift (CS), over same REs. Different phase rotations are then applied to separate the different ports. Applying a phase rotation in frequency domain is equivalent to applying a cyclic shift in time domain. In NR specification the operation is actually referred to as “cyclic shift,” although it is mathematically described as a frequency domain phase shift.

For a 1-SRS-port resource, the port can be mapped to any of the combs and a CS can be applied (to separate SRS port from another UEs transmission by using different CS and/or different comb). For a 2-SRS-port resource, both ports are mapped to the same comb and separated by CS. Any of the combs can be configured for this SRS resource (the other comb can be used by another (e.g., 1-port or 2-port) UE. If this is configured to a single UE, then that is the expectation from that UE). When UE is capable of transmitting, e.g., using 2 panels or 2 beams, the UE can be configured with a multiport SRS resource. But between different UEs, then it is not necessary for the gNB to configure each UE with a multi-port resource. For a 4-SRS-port resource, either all four ports are mapped to the same comb and separated by CS, or groups of two ports are mapped to either of two configured combs, and separated by CS within the group. It is not possible to map a 4-port SRS resource to 4 different combs, CS must be used to separate at least two ports. For four-port and four-comb case when two combs are configured, the two combs cannot be adjacent since that prevents multiplexing another SRS resource in the same OFDM symbol (when using groups of 2 ports, this may limit the capacity to FDM with other UEs).

### A. Discussion: Interference Handling for UL-PRS

To minimize interference among TRPs transmitting DL-PRS and UEs transmitting UL-PRS, the new radio (NR) Rel-16 positioning specification supports multiple interference management techniques. PRSs, on both UL and DL directions, are orthogonalized in code, frequency, and time domains. For code domain orthogonality, QPSK modulated PRS is initialized by a standard 31-bit Gold code sequence in DL and a standard Zadoff-Chu sequence in UL. To maintain frequency domain orthogonality, both UL and DL PRSs can be configured (among interfering nodes) using different comb-phases.

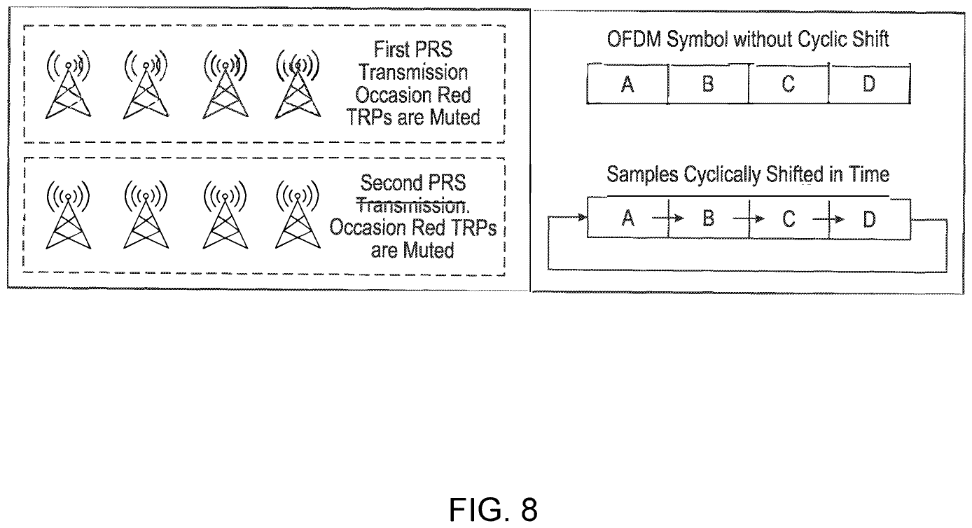

To orthogonalize PRS in the time domain (FIG. 8), cyclic shift configurations are used for UL-PRS, and muting configurations are used for DL-PRS.

FIG. 8 shows an example of TRP muting for comb-2, 2OS DL-PRS transmission (left); Cyclic shift in an OFDM symbol (right).

In one or more embodiments, an enhanced resource management system may facilitate reuse of sensing physical resources by multiplexing in delay domain.

As described earlier, in the communication systems, one way of multiplexing/orthogonalizing the SRS for different users is by using the concept of cyclic shift, i.e., it is possible to use the same SRS comb and multiplex multiple UEs by introducing the cyclic shift.

On the other hand, different initializations and offset values provide pseudo-orthogonality for pseudo-random (PN) sequences generated based on Gold sequence, e.g., as currently used in DL-PRS and several other signals in NR, and can have similar effect as in CS for ZC sequences.

For sensing, the concept of CS can enable reuse of resources for sensing signals. In one example, after performing initial FoV scan(s) covering the full FoV (providing a full snapshot of the environment (possibly without repetitive signal structure for Doppler processing, as in the initial scan may provide a static picture of the entire FoV and the Doppler may not be estimated)), if it is observed that in some directions, widespread of targets exist, while in some other directions, only closer targets exist (e.g., objects closer than a certain threshold which can be determined based on the desired performance, etc.), it is possible to multiplex the sensing signal transmission in the corresponding beam directions using the same physical resource, using cyclic shift. Particularly, within the same UL-PRS (or DL-PRS) resource, different directions can be multiplexed in the delay domain, depending on the targets' placements.

Assume BS's monostatic sensing based on DL-PRS, where in a given direction, there are a widespread of targets, e.g., targets close by and targets far away, etc. in a wide range (this information can be obtained by an initial scan of the FoV). Further, assume that depending on the used frequency comb size, the OFDM symbol can be partitioned into certain number of segments, each denoting one unit of cyclic shift. For the mentioned direction, the signal's sequence may need to use a cyclic shift value of zero (i.e., modulating the sensing signal with zero CS). Further, since for a long spread of targets, the reflection may appear beyond one of the cyclic shifts, the next CS may be left unused in that direction. For the next beam, if only targets in nearby distance exist in that direction, the next available CS value can be used and the reflections will also fall in the same CS. For the next direction, the same procedure to allocate different number of cyclic shift ranges may be continued. For each direction, if it needs a larger range, the next CS can be skipped. This procedure allows to adaptively allocate cyclic shifts, based on the information regarding the targets' placement, collected in the initial scan(s).

Without using a CS, the transmit sequence in the time domain, appears as a single impulse in time zero. The original transmit sequence (without any CS) is called the base sequence. Multiplying the transmit signal with the conjugate of the received reflection, results in a perfect cancellation which in frequency domain, will end up producing all-ones (the IFFT of which is an impulse signal, i.e., a DC component).

For another signal generated based on the base sequence time shifted with a different cyclic shift (a phase rotated version of the original sequence), when its reflection is received, the received sequence is multiplied with the conjugate of the base sequence (which is a phase-rotated version of the base sequence) which results in de-modulated impulse response, which has been shifted in time, since it only cancels out the base part, but keeps the phase rotation part. As such, each CS sequence signal will appear at a different time (determined by the cyclic shift value which is known), when multiplying with the base sequence. By subtracting the cyclic shift value, then the real amount of delay due to the reflection can be calculated and the range can be estimated.

This technique allows to introduce the artificial shift values to enable using the entire available time interval efficiently (it is noted that when the frame structure for sensing is designed, the delay range is usually dimensioned based on the furthest range that the system is expected to detect unambiguously). In scenarios where a single signal (i.e., original base sequence) and its reflections do not expand over the entire allowed time budget (i.e., the impulse response is not as long as the full range of the time axis), this technique results in higher resource efficiency by making use of the time axis by dividing it into multiple sections and sensing the signals at different points in the time axis. As such, this technique presents a delay multiplexing scheme, where based on some initial scan if the FoV, the nature of the field of view is identified, and enables determining the range of targets, and accordingly, determining the number of cyclic shift windows needed to cover these ranges.

in some embodiments, in the design of an OFDM-based JCAS system, in order to mitigate inter-symbol interference (ISI) for sensing signal, the numerology is dimensioned such that for the underlying scenario, the targets to be detected, fall within the cyclic prefix (CP) range. If the performance requirements can tolerate some non-zero ISI, some extended range threshold for targets may be allowed which can be up to several multiples of CP duration, but with degraded range detection performance.

As such, for the cyclic-shift approach disclosed above, the way that the amount of cyclic shift is dimensioned, needs to consider that the entire OFDM symbol duration may not be available for the echoes to come back due to the degraded performance from non-zero ISI (this is equivalent to the maximum unambiguously detectable range of targets for OFDM radar, being far larger than the maximum ISI-free range, e.g., being multiples of CP range (e.g., 7 times the CP)). As such, the cyclic shift approach may only consider partitioning a portion of the OFDM symbol length to dimension the cyclic shift values. For example, for beam directions where the targets are close to the radar, multiple CS windows can be placed over the same symbol, while for directions with further away targets, only a few or a single CS window may be fitted.

This technique can be used both for UL-PRS-based sensing and DL-PRS-based sensing. It is noted that for UL-PRS, in the presence of other UEs transmitting over the same physical resources by using different cyclic shifts, such approach, may require further considerations due to interference limitations. But for scenarios where UEs are separated enough (and do not rely on CS to be multiplexed over same resources), this approach can be applicable without such potential limitations.

In one example, the configuration of DL-PRS is extended to also allow different DL-PRS resources to use the same OFDM symbols and the same frequency resources, using cyclic shifts in time domain of the generated sequence over these resources. The number and the size of cyclic shift windows can be determined and configured (e.g., from a set of predetermined values) based on the numerology, the frequency domain comb-size, and the initial understanding of the targets' locations in different beam directions covered by these DL-PRS resources. In an extended example, while these cyclic shifts are introduced in the context of sensing of the environment based on DL-PRS signal, for UEs configured to detect and measure over these DL-PRS for the purpose of UE positioning, the mapping between the DL-PRS resources and the assigned cyclic shifts are indicated (e.g., via DCI or MAC CE) so that the UE is able to detect the correct sequence.

In one example, the configuration of UL-PRS is extended to also allow different UL-PRS resources use the same OFDM symbols and same frequency resources, using cyclic shifts in time domain of the generated sequence over these resources. The number and the size of cyclic shift windows can be determined based on the numerology, the frequency domain comb-size, and the initial understanding of the targets' locations in different beam directions covered by these UL-PRS resources.

In one example, physical resources for sensing from different nodes (e.g., from different BSs in DL-PRS-based sensing or between UE's in UL-PRS-based sensing) may be reused, based on some preliminary knowledge gathered based on the environment and target ranges and/or beam directions, and applying CS, (to multiplex in delay domain) accordingly as well. This is in the same spirit as multiplexing UE's SRS signals by using CS in 5G NR.

In one or more embodiments, an enhanced resource management system may facilitate reuse of sensing physical resources by multiplexing in Doppler domain.

The dual of the delay multiplexing approach disclosed above may be also considered in Doppler domain (for Doppler multiplexing), e.g., if the targets identified in different directions during the first scan(s), have different ranges of velocities/Dopplers. Particularly, the Doppler spectrum may be shifted into different locations in frequency to reuse the available Doppler range within the same frequency resource (while overall, using the same frequency and time resources).

Assume that in a certain direction, it is known that there are only very low-Doppler targets (e.g., based on the initial scan(s), or knowledge of the environment, e.g., pointing to a car park). In that case, without any cyclic shift in time domain, the targets appear around the zero value. As such, the large portion of the Doppler range will be unused in that certain direction. However, it may be possible to use the rest of the Doppler range by applying some cyclic shifts.

It is noted that when the frame structure for the sensing is designed, the Doppler range is usually dimensioned based on the highest speed that the system is expected to detect (unambiguously). As such, if in other directions of the FoV, high-Doppler targets are expected, e.g., consider a road next to a car park, the dimensioned Doppler range is high. The above technique enables efficient use of the dimensioned Doppler range, for the directions where the entire range is not naturally used due to low-Doppler targets.

For example, for the two beams directing to the car park and the road, the corresponding signals may use the same overall time and frequency resources, with some (artificial) shift in Doppler.

In one example, the configuration of DL-PRS is extended to also allow different DL-PRS resources to use the same OFDM symbols and the same frequency resources while using cyclic shifts in frequency domain of the generated sequence over these resources. The number and the size of cyclic shift windows can be determined and configured (e.g., from a set of predetermined values) based on the numerology, the frequency domain comb-size, and the initial understanding of the targets' speeds in different beam directions covered by these DL-PRS resources. In an extended example, while these cyclic shifts are introduced in the context of sensing of the environment based on DL-PRS signal, for UEs configured to detect and measure over these DL-PRS for the purpose of UE positioning, the mapping between the DL-PRS resources and the assigned cyclic shifts are indicated (e.g., via DCI or MAC CE) so that the UE is able to detect the correct sequence.

In one example, the configuration of UL-PRS is extended to also allow different UL-PRS resources use the same OFDM symbols and the same frequency resources, using cyclic shifts in frequency domain of the generated sequence over these resources. The number and the size of cyclic shift windows can be determined based on the numerology, the frequency domain comb-size, and the initial understanding of the targets' speeds in different beam directions covered by these UL-PRS resources.

In one or more embodiments, an enhanced resource management system may cause a sensing entity to map the sensing modulated symbols to time and frequency resources of an Orthogonal Frequency Division Multiplexing (OFDM) resource grid, recurring OFDM symbols are occupied by the sensing modulated symbols based on a plurality of sets of integer values {T_{SRI},k}, where T_{SRI} is the periodicity with which such sensing modulated symbols are mapped to OFDM symbols (where SRI stands for Symbol Repetition Interval), and k×T_{SRI}, determines the total time span (in number of OFDM symbols) over which the repeated occurrence of sensing symbols continues (with the periodicity of T_{SRI}), i.e., sensing block duration, a

$${T}_{SRI , 1} \leq \frac{{c}_{0}}{4 {f}_{c} {v}_{max}} ,$$

where c₀ denotes the speed of light, and ƒ_{c} denotes the carrier frequency, and νₘₐₓ denotes the maximum desired velocity to be reliably detected by the processor circuitry, while the full sensing block duration, k1×T_{SRI,1}, is smaller than required to meet the velocity resolution (i.e.,

$$k 1 < \frac{{c}_{0}}{4 {f}_{c} Δ v \times {T}_{SRI , 1}} ,$$

where αν denotes the resolution with which the velocity needs to be detected), and a

$${T}_{SRI , 2} > \frac{{c}_{0}}{4 {f}_{c} {v}_{max}}$$

(i.e., configured larger than required for scanning the required velocity range), while the sensing block duration k2×T_{SRI,2} is as required to meet the velocity resolution

$$( i . e . , k 2 \geq \frac{{c}_{0}}{4 {f}_{c} Δ v \times {T}_{SRI , 2}} ) ,$$

and T_{SRI,2}≤k1×T_{SRI,1}, transmit the sensing modulated symbols according to the two repetition patterns, with the same spatial precoding (beams), while the order of beams may be different between the different blocks.

In one or more embodiments, an enhanced resource management system may map the communication modulated symbols to time and frequency resources of the same OFDM resource grid such that a plurality of OFDM symbols within each SRI are used to carry communication signal (intra-block-level (intra-SRI-level) TDM), and transmit the communication modulated symbols.

In one or more embodiments, when the whole time-span of the repetition patterns (i.e., the sensing block consisting of k×T_{SRI} OFDM symbols) are each repeated based on certain update rates, the later occurrences of one or both patterns (e.g., in terms of one or multiple aspects of the scanned FoV, the SRI duration, the value of k (i.e., the sensing block duration)) are modified/fine-tuned based on the initial occurrence(s) of the sensing blocks.

In one or more embodiments, the update rate of the sensing block with parameters {T_{SRI,1},k1}, is higher than the update rate of the sensing block with parameters {T_{SRI,2},k2}.

In one or more embodiments, if the update rate of the sensing block with parameters {T_{SRI,1},k1}, is smaller than k2×T_{SRI,2}, the sensing block with parameters {T_{SRI,1},k1}, is transmitted multiple times within the duration of the sensing block with parameters {T_{SRI,2},k2}.

In one or more embodiments, an enhanced resource management system may map and transmit the modulated symbols, according to 5G NR Downlink (DL) PRS design, wherein plurality of PRS resource sets are configured such that each PRS resource set realizes a sensing block corresponding to one group of parameters {T_{SRI},k} and possible durations for PRS resource set, is based on repetition parameters and the number of resources within the set, and number of PRS resources within a PRS resource set corresponds to the number of beam directions covered within SRI, and SRI corresponds to the collection of one occurrence of all PRS resources within the set, and repetition factor for PRS resource repetition within one instance of resource set, corresponds to the integer value k, and the periodicity of the resource set corresponds to the update rate for sensing.

In one or more embodiments, a frequency comb structure is used between two PRS resource sets over the same symbols and depending on whether the two resource sets need to cover the same beam directions, the DL-PRS resources within the two sets are configured accordingly.

In one or more embodiments, the plurality of groups of parameters {T_{SRI},k} is realized via one set of configurations for the PRS resource set, but with two sets of values configured for the repetition gap and repetition factor, and a parameter indicating the relative offset between the starting of the two sets.

In one or more embodiments, every beam direction (DL-PRS resource) is transmitted accordingly to the repetition pattern of the long sparse set, except during the time span indicated by these parameters wherein it will be transmitted according to the pattern of the short dense set.

In one or more embodiments, QCL relations are defined between two DL-PRS resource sets, to identify DL-PRS resources (beams) used for the first and second scans according to the two repetition patterns and sensing block durations.

In one or more embodiments, DL-PRS configurations allow DL-PRS repetition gap in granularity of half-slot, where the repetition factor counts the number of half-slots that it repeats.

In one or more embodiments, DL-PRS configurations allow the DL-PRS set to span over first half of a slot and allows for configuring a repetition gap of zero (e.g., in number of half-slots).

In one or more embodiments, an enhanced resource management system may map and transmit the modulated symbols, according to 5G NR UL PRS design, wherein the following equivalences are used (marked with ↔).

In one or more embodiments, UL-PRS resource↔sensing beam (for UL-based positioning, single port UL-PRS resource is supported, i.e., each UL-PRS resource is dedicated for transmission in a single direction). A resource corresponds to an SRS beam, and resource sets correspond to a collection of SRS resource (i.e., beams) aimed at a given TRP.

In one or more embodiments, The number of PRS resources within a PRS resource set↔the number of beam directions in SRI. This is also related to the number of OFDM symbols in each SRS resource of the set and how they are located. For sensing, smaller number of interleaved comb are preferred, because compared to the larger number of interleaves combs, they utilize more subcarriers and provide more intra-SRI flexibility of assigning OFDM symbols to different directions and/or for different purposes (UL-PRS vs non-PRS), while also imposes less limitation on the maximum unambiguously detectable range.

In one or more embodiments, resource set together with periodicity/repetition parameters and the number and distancing of resources within the set↔SRI (collection of one occurrence of all PRS resources within the set). In an SRS resource set, multiple SRS resources, each for one direction is transmitted. For comb-2/2-OS, there can be 1, 2, 4, or 6 repetitions within one SRS resource. This is equivalent to using multiple SRI symbols for repetition of a same direction and processing gain.

In one or more embodiments, the entire time interval which contains repetitions of resource set with its periodicity (i.e., repetitions of SRI)↔sensing block-possible durations is based on network configuration. Across SRIs within a sensing block, the number and pattern of sensing resources and directions is configured the same to achieve consistent configuration of SRS resources in periodic occurrences of SRS resource sets. The same number and placement of OFDM symbols across all SRIs is also considered for non-PRS transmissions. The number of repetitions of SRS resource set↔Doppler FFT size, K.

In one or more embodiments, how frequent periodic occurrence can be (re-)configured↔update rate for sensing (the minimum achievable update rate may be related to the signaling limitations), and a plurality of UL-PRS resource sets with their respective periodic occurrences are configured such that each set realizes a sensing block corresponding to one set of parameters {T_{SRI},k}.

In one or more embodiments, a frequency comb structure is used between the two sets over the same symbols and depending on whether the two sets need to cover the same beam directions, the UL-PRS resources within the two sets are configured accordingly. In one or more embodiments, the plurality of groups of parameters {T_{SRI},k} is realized via one set of configurations for the PRS resource set, but with two values configured for the periodicity, and a parameter indicating the relative offset between the starting of the two periodicities (e.g., how much earlier or later one periodicity may start using positive and/or negative values, which can be defined in granularity of OFDM symbol, or half-slot, etc.).

In one or more embodiments, the plurality of groups of parameters {T_{SRI},k} is realized via one set of configurations for the PRS resource set, but with two sets of values configured for the periodicity and the duration parameter (indicating how long the periodic occurrences of UL-PRS resource sets continues for), and a parameter indicating the relative offset between the starting of the two periodicities.

In one or more embodiments, every beam direction (UL-PRS resource) is transmitted accordingly to the periodicity of the long sparse set, except during the time span indicated by these parameters wherein it will be transmitted according to the pattern of the short dense set

In one or more embodiments, an enhanced resource management system may be configured at the receive entity to process the sensing symbols transmitted according to the plurality of sets of values {T_{SRI},k}, by producing plurality of sets of complex data correspondingly, where each set of complex data contains information regarding the Delay-Doppler bins (e.g., calculated via range IDFT and Doppler DFT), and is processed separately for angle of arrival, e.g., to obtain two sets of angle-of-arrival (AoA) estimations.

In one or more embodiments, the two AoA estimations are combined via a weighted sum or the maximum ratio combining (MRC), or any other detection method.

In one or more embodiments, an enhanced resource management system may comprise an apparatus used in a sensing, device localization/positioning, and communication system wherein the apparatus comprises a processor circuitry configured the sensing and localization entities to map and transmit the modulated symbols, according to 5G NR Downlink (DL) PRS design, such that two values are configured for the PRS repetition factor: one value indicating the maximum value required for sensing, and the other value configured for localization/positioning).

In one or more embodiments, the user equipment (UE) performs measurement of the PRS signal, based on the smaller value of the repetition factor if it intends to.

In one or more embodiments, the user equipment (UE) can decide on a number of repetitions based on the indicated minimum and maximum values, and perform the measurements accordingly, and optionally, indicate the assumed number in an UL control transmission.

In one or more embodiments, the user equipment (UE) transmits termination indication, to indicate to the DL-PRS's transmitted, the instance it stops processing the repetitions.

In one or more embodiments, an enhanced resource management system may be used in a sensing and communication system wherein the apparatus comprises a processor circuitry configured the sensing entity to map and transmit the modulated symbols according to 5G NR Downlink (DL) PRS design, such that plurality of DL-PRS resource or DL-PRS resource set configurations, e.g., the ones determining the time domain pattern for DL-PRS such as the set periodicity, are configured or overridden through DCI indication or MAC CE.

In one or more embodiments, an enhanced resource management system may be used in a sensing and communication system wherein the apparatus comprises a processor circuitry configured the sensing entity to map and transmit the modulated symbols according to 5G NR Downlink (DL) PRS design, such that QCL relations are defined between DL-PRS resources (beams) used for different/consecutive configurations of PRS resource sets for the purpose of sensing and field of view (FoV) scans.

In one or more embodiments, an enhanced resource management system may be used in a sensing and communication system wherein the apparatus comprises a processor circuitry configured the sensing entity to map and transmit the modulated symbols according to 5G NR Downlink (UL) PRS design, such that after initial FoV scan(s) based on the RRC-configured parameters for UL-PRS, for UE monostatic sensing scenarios, the UE can indicate the required periodicity (ies), the required overall interval over which the periodic occurrences happen, and/or the potential directions to be scanned, and the gNB then configures the UL-PRS accordingly, based on RRC signaling, MAC CE, or DCI indication.

In one or more embodiments, an enhanced resource management system may be used in a sensing and communication system wherein the apparatus comprises a processor circuitry configured the sensing entity to map and transmit the modulated symbols according to 5G NR Downlink (UL) PRS design, such that one or multiple of the UL-PRS resource and resource set configuration parameters (e.g., the ones determining the time domain pattern for UL-PRS) are configured or overridden through DCI indication or MAC CE.

In one or more embodiments, an enhanced resource management system may be used in a sensing and communication system wherein the apparatus comprises a processor circuitry configured the sensing entity to map and transmit the modulated symbols according to 5G NR Downlink (UL) PRS design, such that QCL relations are defined between UL-PRS resources (beams) used for different/consecutive configurations of PRS resource sets for the purpose of sensing and field of view (FoV) scans.

In one or more embodiments, an enhanced resource management system may be used in a sensing and communication system wherein the apparatus comprises a processor circuitry configured the sensing entity to map and transmit the modulated symbols according to 5G NR Downlink (DL) PRS design, after performing initial FoV scan(s) using certain configuration of values {T_{SRI},k}, if it is observed that in some directions, widespread of targets exist, while in some other directions, only closer targets exist (e.g., objects closer than a certain configurable threshold), the sensing signal transmission in the corresponding beam directions are multiplexed using the same time/frequency resources, by configuring cyclic shift values, such that within the same DL-PRS resource, different directions are multiplexed in the delay domain, depending on the targets' placements.

In one or more embodiments, an enhanced resource management system may be used in a sensing and communication system wherein the apparatus comprises a processor circuitry configured the sensing entity to map and transmit the modulated symbols according to 5G NR UL PRS design, after performing initial FoV scan(s) using certain configuration of values {T_{SRI},k}, if it is observed that in some directions, widespread of targets exist, while in some other directions, only closer targets exist (e.g., objects closer than a certain configurable threshold), the sensing signal transmission in the corresponding beam directions are multiplexed using the same time/frequency resources, by configuring cyclic shift values, such that within the same UL-PRS resource, different directions are multiplexed in the delay domain, depending on the targets' placements.

In one or more embodiments, an enhanced resource management system may be used in a sensing entity wherein the apparatus comprises processor circuitry configured to cause the sensing entity to map and transmit the modulated symbols, according to 5G NR Downlink (DL) PRS design, where the configuration of DL-PRS is extended to also allow different DL-PRS resources to use the same OFDM symbols and the same frequency resources, using cyclic shifts in time domain of the generated sequence over these resources, and the number and the size of cyclic shift windows is determined and configured (e.g., from a set of predetermined values) based on the numerology, the frequency domain comb-size, and the initial understanding of the targets' locations in different beam directions covered by these DL-PRS resources.

In one or more embodiments, an enhanced resource management system may be used in a sensing entity wherein the apparatus comprises processor circuitry configured to cause the sensing entity to map and transmit the modulated symbols, according to 5G NR Downlink (DL) PRS design, where the configuration of DL-PRS is extended to also allow different DL-PRS resources to use the same OFDM symbols and the same frequency resources, using cyclic shifts in in frequency domain of the generated sequence over these resources, and the number and the size of cyclic shift windows is determined and configured (e.g., from a set of predetermined values) based on the numerology, the frequency domain comb-size, and the initial understanding of the targets' speeds in different beam directions covered by these DL-PRS resources.

In one or more embodiments, the mapping between the DL-PRS resources and the assigned cyclic shifts are indicated via DCI or MAC CE, so that the UE is able to detect the correct sequence.

In one or more embodiments, an enhanced resource management system may be used in a sensing entity wherein the apparatus comprises processor circuitry configured to cause the sensing entity to map and transmit the modulated symbols, according to 5G NR UL PRS design, where the configuration of UL-PRS is extended to also allow different UL-PRS resources to use the same OFDM symbols and the same frequency resources, using cyclic shifts in time domain of the generated sequence over these resources, and the number and the size of cyclic shift windows is determined and configured (e.g., from a set of predetermined values) based on the numerology, the frequency domain comb-size, and the initial understanding of the targets' locations in different beam directions covered by these UL-PRS resources.

In one or more embodiments, an enhanced resource management system may be used in a sensing entity wherein the apparatus comprises processor circuitry configured to cause the sensing entity to map and transmit the modulated symbols based on the time and frequency resources in an OFDM system, and the time and frequency resources used for sensing from different nodes can be reused, based on preliminary knowledge of the environment and target ranges and/or beam directions, and by applying CS (to multiplex in delay domain) accordingly.

In one or more embodiments, an enhanced resource management system may be used in a sensing entity wherein the apparatus comprises processor circuitry configured to cause the sensing entity to map and transmit the modulated symbols, according to 5G NR UL PRS design, where the configuration of UL-PRS is extended to also allow different UL-PRS resources to use the same OFDM symbols and the same frequency resources, using cyclic shifts in frequency domain of the generated sequence over these resources, and the number and the size of cyclic shift windows is determined and configured (e.g., from a set of predetermined values) based on the numerology, the frequency domain comb-size, and the initial understanding of the targets' speeds in different beam directions covered by these UL-PRS resources.

It is understood that the above descriptions are for the purposes of illustration and are not meant to be limiting.

### REFERENCES

[1] T. Wild et al.: Joint Design of Communication and Sensing for Beyond 5G and 6G Systems.
[2] Hermann Rohling and Matthias Kronauge, “New Radar Waveform based on a Chirp Sequence”, International Radar Conference, 2014.
[3] Hexa-X WP3 first deliverable D3.1 (Section 3.1), published at the end of 2021.

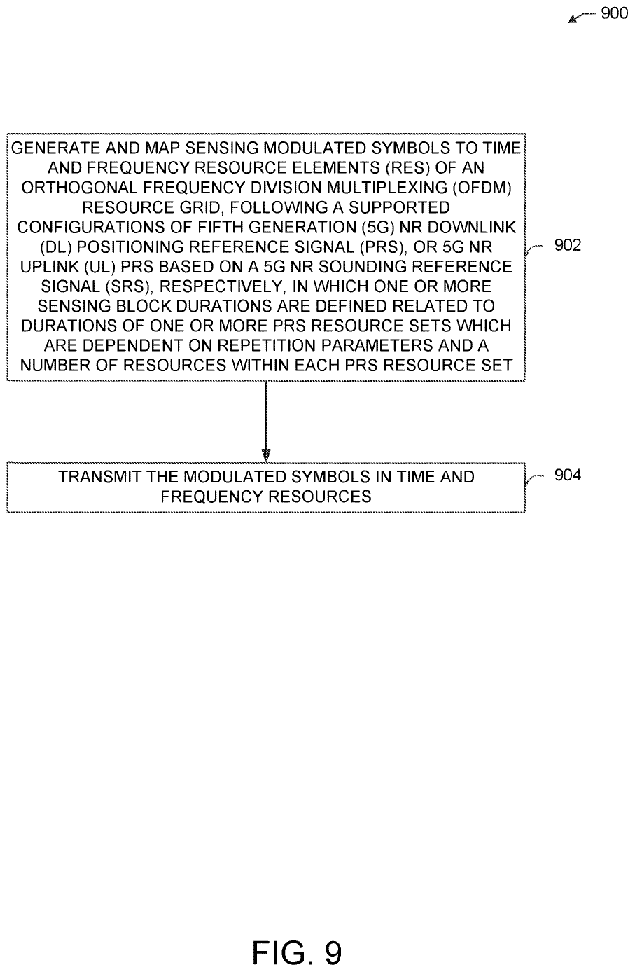

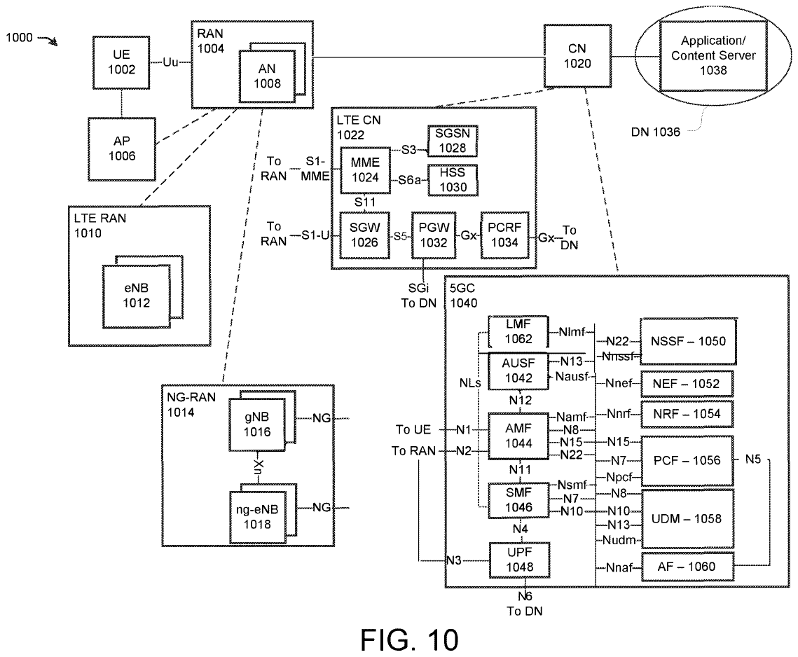

In some embodiments, the electronic device(s), network(s), system(s), chip(s) or component(s), or portions or implementations thereof, of FIGS. 10-12, or some other figure herein, may be configured to perform one or more processes, techniques, or methods as described herein, or portions thereof. One such process is depicted in FIG. 9.

For example, the process may include, at 902, generating and map sensing modulated symbols to time and frequency resource elements (REs) of an Orthogonal Frequency Division Multiplexing (OFDM) resource grid, following a supported configurations of fifth generation (5G) NR Downlink (DL) Positioning Reference Signal (PRS), or 5G NR Uplink (UL) PRS based on a 5G NR Sounding Reference Signal (SRS), respectively, in which one or more sensing block durations are defined related to durations of one or more PRS resource sets which are dependent on repetition parameters and a number of resources within each PRS resource set.

The process further includes, at 904, transmitting the modulated symbols in time and frequency resources.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

It is understood that the above descriptions are for purposes of illustration and are not meant to be limiting.

FIGS. 10-13 illustrate various systems, devices, and components that may implement aspects of disclosed embodiments.

FIG. 10 illustrates an example network architecture 1000 according to various embodiments. The network 1000 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1000 includes a UE 1002, which is any mobile or non-mobile computing device designed to communicate with a RAN 1004 via an over-the-air connection. The UE 1002 is communicatively coupled with the RAN 1004 by a Uu interface, which may be applicable to both LTE and NR systems. Examples of the UE 1002 include, but are not limited to, a smartphone, tablet computer, wearable computer, desktop computer, laptop computer, in-vehicle infotainment system, in-car entertainment system, instrument cluster, head-up display (HUD) device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, machine-to-machine (M2M), device-to-device (D2D), machine-type communication (MTC) device, Internet of Things (IoT) device, and/or the like. The network 1000 may include a plurality of UEs 1002 coupled directly with one another via a D2D, ProSe, PC5, and/or sidelink (SL) interface. These UEs 1002 may be M2M/D2D/MTC/IoT devices and/or vehicular systems that communicate using physical sidelink channels such as, but not limited to, PSBCH, PSDCH, PSSCH, PSCCH, PSFCH, etc. The UE 1002 may perform blind decoding attempts of SL channels/links according to the various embodiments herein.

In some embodiments, the UE 1002 may additionally communicate with an AP 1006 via an over-the-air (OTA) connection. The AP 1006 manages a WLAN connection, which may serve to offload some/all network traffic from the RAN 1004. The connection between the UE 1002 and the AP 1006 may be consistent with any IEEE 802.11 protocol. Additionally, the UE 1002, RAN 1004, and AP 1006 may utilize cellular-WLAN aggregation/integration (e.g., LWA/LWIP). Cellular-WLAN aggregation may involve the UE 1002 being configured by the RAN 1004 to utilize both cellular radio resources and WLAN resources.

The RAN 1004 includes one or more access network nodes (ANs) 1008. The ANs 1008 terminate air-interface(s) for the UE 1002 by providing access stratum protocols including RRC, PDCP, RLC, MAC, and PHY/L1 protocols. In this manner, the AN 1008 enables data/voice connectivity between CN 1020 and the UE 1002. The ANs 1008 may be a macrocell base station or a low power base station for providing femtocells, picocells or other like cells having smaller coverage areas, smaller user capacity, or higher bandwidth compared to macrocells; or some combination thereof. In these implementations, an AN 1008 be referred to as a BS, gNB, RAN node, eNB, ng-eNB, NodeB, RSU, TRxP, etc.

One example implementation is a “CU/DU split” architecture where the ANs 1008 are embodied as a gNB-Central Unit (CU) that is communicatively coupled with one or more gNB-Distributed Units (DUs), where each DU may be communicatively coupled with one or more Radio Units (RUS) (also referred to as RRHs, RRUs, or the like) (see e.g., 3GPP TS 38.401 v16.1.0 (2020-03)). In some implementations, the one or more RUs may be individual RSUs. In some implementations, the CU/DU split may include an ng-eNB-CU and one or more ng-eNB-DUs instead of, or in addition to, the gNB-CU and gNB-DUs, respectively. The ANs 1008 employed as the CU may be implemented in a discrete device or as one or more software entities running on server computers as part of, for example, a virtual network including a virtual Base Band Unit (BBU) or BBU pool, cloud RAN (CRAN), Radio Equipment Controller (REC), Radio Cloud Center (RCC), centralized RAN (C-RAN), virtualized RAN (vRAN), and/or the like (although these terms may refer to different implementation concepts). Any other type of architectures, arrangements, and/or configurations can be used.

The plurality of ANs may be coupled with one another via an X2 interface (if the RAN 1004 is an LTE RAN or Evolved Universal Terrestrial Radio Access Network (E-UTRAN) 1010) or an Xn interface (if the RAN 1004 is a NG-RAN 1014). The X2/Xn interfaces, which may be separated into control/user plane interfaces in some embodiments, may allow the ANs to communicate information related to handovers, data/context transfers, mobility, load management, interference coordination, etc.

The ANs of the RAN 1004 may each manage one or more cells, cell groups, component carriers, etc. to provide the UE 1002 with an air interface for network access. The UE 1002 may be simultaneously connected with a plurality of cells provided by the same or different ANs 1008 of the RAN 1004. For example, the UE 1002 and RAN 1004 may use carrier aggregation to allow the UE 1002 to connect with a plurality of component carriers, each corresponding to a Pcell or Scell. In dual connectivity scenarios, a first AN 1008 may be a master node that provides an MCG and a second AN 1008 may be secondary node that provides an SCG. The first/second ANs 1008 may be any combination of eNB, gNB, ng-eNB, etc.

The RAN 1004 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1002 or AN 1008 may be or act as a roadside unit (RSU), which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1004 may be an E-UTRAN 1010 with one or more eNBs 1012. The an E-UTRAN 1010 provides an LTE air interface (Uu) with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1004 may be an next generation (NG)-RAN 1014 with one or more gNB 1016 and/or on or more ng-eNB 1018. The gNB 1016 connects with 5G-enabled UEs 1002 using a 5G NR interface. The gNB 1016 connects with a 5GC 1040 through an NG interface, which includes an N2 interface or an N3 interface. The ng-eNB 1018 also connects with the 5GC 1040 through an NG interface, but may connect with a UE 1002 via the Uu interface. The gNB 1016 and the ng-eNB 1018 may connect with each other over an Xn interface.

In some embodiments, the NG interface may be split into two parts, an NG user plane (NG-U) interface, which carries traffic data between the nodes of the NG-RAN 1014 and a UPF 1048 (e.g., N3 interface), and an NG control plane (NG-C) interface, which is a signaling interface between the nodes of the NG-RAN 1014 and an AMF 1044 (e.g., N2 interface).

The NG-RAN 1014 may provide a 5G-NR air interface (which may also be referred to as a Uu interface) with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

The 5G-NR air interface may utilize BWPs for various purposes. For example, BWP can be used for dynamic adaptation of the SCS. For example, the UE 1002 can be configured with multiple BWPs where each BWP configuration has a different SCS. When a BWP change is indicated to the UE 1002, the SCS of the transmission is changed as well. Another use case example of BWP is related to power saving. In particular, multiple BWPs can be configured for the UE 1002 with different amount of frequency resources (e.g., PRBs) to support data transmission under different traffic loading scenarios. A BWP containing a smaller number of PRBs can be used for data transmission with small traffic load while allowing power saving at the UE 1002 and in some cases at the gNB 1016. A BWP containing a larger number of PRBs can be used for scenarios with higher traffic load.

The RAN 1004 is communicatively coupled to CN 1020 that includes network elements and/or network functions (NFs) to provide various functions to support data and telecommunications services to customers/subscribers (e.g., UE 1002). The components of the CN 1020 may be implemented in one physical node or separate physical nodes. In some embodiments, NFV may be utilized to virtualize any or all of the functions provided by the network elements of the CN 1020 onto physical compute/storage resources in servers, switches, etc. A logical instantiation of the CN 1020 may be referred to as a network slice, and a logical instantiation of a portion of the CN 1020 may be referred to as a network sub-slice.

The CN 1020 may be an LTE CN 1022 (also referred to as an Evolved Packet Core (EPC) 1022). The EPC 1022 may include MME 1024, SGW 1026, SGSN 1028, HSS 1030, PGW 1032, and PCRF 1034 coupled with one another over interfaces (or “reference points”) as shown. The NFs in the EPC 1022 are briefly introduced as follows.

The MME 1024 implements mobility management functions to track a current location of the UE 1002 to facilitate paging, bearer activation/deactivation, handovers, gateway selection, authentication, etc.

The SGW 1026 terminates an S1 interface toward the RAN 1010 and routes data packets between the RAN 1010 and the EPC 1022. The SGW 1026 may be a local mobility anchor point for inter-RAN node handovers and also may provide an anchor for inter-3GPP mobility. Other responsibilities may include lawful intercept, charging, and some policy enforcement.

The SGSN 1028 tracks a location of the UE 1002 and performs security functions and access control. The SGSN 1028 also performs inter-EPC node signaling for mobility between different RAT networks; PDN and S-GW selection as specified by MME 1024; MME 1024 selection for handovers; etc. The S3 reference point between the MME 1024 and the SGSN 1028 enable user and bearer information exchange for inter-3GPP access network mobility in idle/active states.

The HSS 1030 includes a database for network users, including subscription-related information to support the network entities' handling of communication sessions. The HSS 1030 can provide support for routing/roaming, authentication, authorization, naming/addressing resolution, location dependencies, etc. An S6a reference point between the HSS 1030 and the MME 1024 may enable transfer of subscription and authentication data for authenticating/authorizing user access to the EPC 1020.

The PGW 1032 may terminate an SGi interface toward a data network (DN) 1036 that may include an application (app)/content server 1038. The PGW 1032 routes data packets between the EPC 1022 and the data network 1036. The PGW 1032 is communicatively coupled with the SGW 1026 by an S5 reference point to facilitate user plane tunneling and tunnel management. The PGW 1032 may further include a node for policy enforcement and charging data collection (e.g., PCEF). Additionally, the SGi reference point may communicatively couple the PGW 1032 with the same or different data network 1036. The PGW 1032 may be communicatively coupled with a PCRF 1034 via a Gx reference point.

The PCRF 1034 is the policy and charging control element of the EPC 1022. The PCRF 1034 is communicatively coupled to the app/content server 1038 to determine appropriate QoS and charging parameters for service flows. The PCRF 1032 also provisions associated rules into a PCEF (via Gx reference point) with appropriate TFT and QCI.

The CN 1020 may be a 5GC 1040 including an AUSF 1042, AMF 1044, SMF 1046, UPF 1048, NSSF 1050, NEF 1052, NRF 1054, PCF 1056, UDM 1058, and AF 1060 coupled with one another over various interfaces as shown. The NFs in the 5GC 1040 are briefly introduced as follows.

The AUSF 1042 stores data for authentication of UE 1002 and handle authentication-related functionality. The AUSF 1042 may facilitate a common authentication framework for various access types.

The AMF 1044 allows other functions of the 5GC 1040 to communicate with the UE 1002 and the RAN 1004 and to subscribe to notifications about mobility events with respect to the UE 1002. The AMF 1044 is also responsible for registration management (e.g., for registering UE 1002), connection management, reachability management, mobility management, lawful interception of AMF-related events, and access authentication and authorization. The AMF 1044 provides transport for SM messages between the UE 1002 and the SMF 1046, and acts as a transparent proxy for routing SM messages. AMF 1044 also provides transport for SMS messages between UE 1002 and an SMSF. AMF 1044 interacts with the AUSF 1042 and the UE 1002 to perform various security anchor and context management functions. Furthermore, AMF 1044 is a termination point of a RAN-CP interface, which includes the N2 reference point between the RAN 1004 and the AMF 1044. The AMF 1044 is also a termination point of NAS (N1) signaling, and performs NAS ciphering and integrity protection.

AMF 1044 also supports NAS signaling with the UE 1002 over an N3IWF interface. The N3IWF provides access to untrusted entities. N3IWF may be a termination point for the N2 interface between the (R)AN 1004 and the AMF 1044 for the control plane, and may be a termination point for the N3 reference point between the (R)AN 1014 and the 1048 for the user plane. As such, the AMF 1044 handles N2 signalling from the SMF 1046 and the AMF 1044 for PDU sessions and QoS, encapsulate/de-encapsulate packets for IPSec and N3 tunnelling, marks N3 user-plane packets in the uplink, and enforces QoS corresponding to N3 packet marking taking into account QoS requirements associated with such marking received over N2. N3IWF may also relay UL and DL control-plane NAS signalling between the UE 1002 and AMF 1044 via an N1 reference point between the UE 1002 and the AMF 1044, and relay uplink and downlink user-plane packets between the UE 1002 and UPF 1048. The N3IWF also provides mechanisms for IPsec tunnel establishment with the UE 1002. The AMF 1044 may exhibit an Namf service-based interface, and may be a termination point for an N14 reference point between two AMFs 1044 and an N17 reference point between the AMF 1044 and a 5G-EIR (not shown by FIG. 10).

The SMF 1046 is responsible for SM (e.g., session establishment, tunnel management between UPF 1048 and AN 1008); UE IP address allocation and management (including optional authorization); selection and control of UP function; configuring traffic steering at UPF 1048 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1044 over N2 to AN 1008; and determining SSC mode of a session. SM refers to management of a PDU session, and a PDU session or “session” refers to a PDU connectivity service that provides or enables the exchange of PDUs between the UE 1002 and the DN 1036.

The UPF 1048 acts as an anchor point for intra-RAT and inter-RAT mobility, an external PDU session point of interconnect to data network 1036, and a branching point to support multi-homed PDU session. The UPF 1048 also performs packet routing and forwarding, packet inspection, enforces user plane part of policy rules, lawfully intercept packets (UP collection), performs traffic usage reporting, perform QoS handling for a user plane (e.g., packet filtering, gating, UL/DL rate enforcement), performs uplink traffic verification (e.g., SDF-to-QoS flow mapping), transport level packet marking in the uplink and downlink, and performs downlink packet buffering and downlink data notification triggering. UPF 1048 may include an uplink classifier to support routing traffic flows to a data network.

The NSSF 1050 selects a set of network slice instances serving the UE 1002. The NSSF 1050 also determines allowed NSSAI and the mapping to the subscribed S-NSSAIs, if needed. The NSSF 1050 also determines an AMF set to be used to serve the UE 1002, or a list of candidate AMFs 1044 based on a suitable configuration and possibly by querying the NRF 1054. The selection of a set of network slice instances for the UE 1002 may be triggered by the AMF 1044 with which the UE 1002 is registered by interacting with the NSSF 1050; this may lead to a change of AMF 1044. The NSSF 1050 interacts with the AMF 1044 via an N22 reference point; and may communicate with another NSSF in a visited network via an N31 reference point (not shown).

The NEF 1052 securely exposes services and capabilities provided by 3GPP NFs for third party, internal exposure/re-exposure, AFs 1060, edge computing or fog computing systems (e.g., edge compute node, etc. In such embodiments, the NEF 1052 may authenticate, authorize, or throttle the AFs. NEF 1052 may also translate information exchanged with the AF 1060 and information exchanged with internal network functions.

The NRF 1054 supports service discovery functions, receives NF discovery requests from NF instances, and provides information of the discovered NF instances to the requesting NF instances. NRF 1054 also maintains information of available NF instances and their supported services. The NRF 1054 also supports service discovery functions, wherein the NRF 1054 receives NF Discovery Request from NF instance or an SCP (not shown), and provides information of the discovered NF instances to the NF instance or SCP.

The PCF 1056 provides policy rules to control plane functions to enforce them, and may also support unified policy framework to govern network behavior. The PCF 1056 may also implement a front end to access subscription information relevant for policy decisions in a UDR of the UDM 1058. In addition to communicating with functions over reference points as shown, the PCF 1056 exhibit an Npcf service-based interface.

The UDM 1058 handles subscription-related information to support the network entities' handling of communication sessions, and stores subscription data of UE 1002. For example, subscription data may be communicated via an N8 reference point between the UDM 1058 and the AMF 1044. The UDM 1058 may include two parts, an application front end and a UDR. The UDR may store subscription data and policy data for the UDM 1058 and the PCF 1056, and/or structured data for exposure and application data (including PFDs for application detection, application request information for multiple UEs 1002) for the NEF 1052.

AF 1060 provides application influence on traffic routing, provide access to NEF 1052, and interact with the policy framework for policy control. The AF 1060 may influence UPF 1048 (re)selection and traffic routing. Based on operator deployment, when AF 1060 is considered to be a trusted entity, the network operator may permit AF 1060 to interact directly with relevant NFs. Additionally, the AF 1060 may be used for edge computing implementations,

The 5GC 1040 may enable edge computing by selecting operator/3rd party services to be geographically close to a point that the UE 1002 is attached to the network. This may reduce latency and load on the network. In edge computing implementations, the 5GC 1040 may select a UPF 1048 close to the UE 1002 and execute traffic steering from the UPF 1048 to DN 1036 via the N6 interface. This may be based on the UE subscription data, UE location, and information provided by the AF 1060, which allows the AF 1060 to influence UPF (re)selection and traffic routing.

The data network (DN) 1036 may represent various network operator services, Internet access, or third party services that may be provided by one or more servers including, for example, application (app)/content server 1038. The DN 1036 may be an operator external public, a private PDN, or an intra-operator packet data network, for example, for provision of IMS services. In this embodiment, the app server 1038 can be coupled to an IMS via an S-CSCF or the I-CSCF. In some implementations, the DN 1036 may represent one or more local area DNs (LADNs), which are DNs 1036 (or DN names (DNNs)) that is/are accessible by a UE 1002 in one or more specific areas. Outside of these specific areas, the UE 1002 is not able to access the LADN/DN 1036.

Additionally or alternatively, the DN 1036 may be an Edge DN 1036, which is a (local) Data Network that supports the architecture for enabling edge applications.

In some embodiments, the 5GS can use one or more edge compute nodes to provide an interface and offload processing of wireless communication traffic. In these embodiments, the edge compute nodes may be included in, or co-located with one or more RAN 1010, 1014. For example, the edge compute nodes can provide a connection between the RAN 1014 and UPF 1048 in the 5GC 1040. The edge compute nodes can use one or more NFV instances instantiated on virtualization infrastructure within the edge compute nodes to process wireless connections to and from the RAN 1014 and UPF 1048.

The interfaces of the 5GC 1040 include reference points and service-based interfaces. The reference points include: N1 (between the UE 1002 and the AMF 1044), N2 (between RAN 1014 and AMF 1044), N3 (between RAN 1014 and UPF 1048), N4 (between the SMF 1046 and UPF 1048), N5 (between PCF 1056 and AF 1060), N6 (between UPF 1048 and DN 1036), N7 (between SMF 1046 and PCF 1056), N8 (between UDM 1058 and AMF 1044), N9 (between two UPFs 1048), N10 (between the UDM 1058 and the SMF 1046), N11 (between the AMF 1044 and the SMF 1046), N12 (between AUSF 1042 and AMF 1044), N13 (between AUSF 1042 and UDM 1058), N14 (between two AMFs 1044; not shown), N15 (between PCF 1056 and AMF 1044 in case of a non-roaming scenario, or between the PCF 1056 in a visited network and AMF 1044 in case of a roaming scenario), N16 (between two SMFs 1046; not shown), and N22 (between AMF 1044 and NSSF 1050).

The 5GS may also include an SCP (or individual instances of the SCP) that supports indirect communication (see e.g., 3GPP TS 23.501 section 7.1.1); delegated discovery (see e.g., 3GPP TS 23.501 section 7.1.1); message forwarding and routing to destination NF/NF service(s), communication security (e.g., authorization of the NF Service Consumer to access the NF Service Producer API) (see e.g., 3GPP TS 33.501), load balancing, monitoring, overload control, etc.; and discovery and selection functionality for UDM(s), AUSF(s), UDR(s), PCF(s) with access to subscription data stored in the UDR based on UE's SUPI, SUCI or GPSI (see e.g., 3GPP TS 23.501 section 6.3). Load balancing, monitoring, overload control functionality provided by the SCP may be implementation specific. The SCP may be deployed in a distributed manner. More than one SCP can be present in the communication path between various NF Services. The SCP, although not an NF instance, can also be deployed distributed, redundant, and scalable.

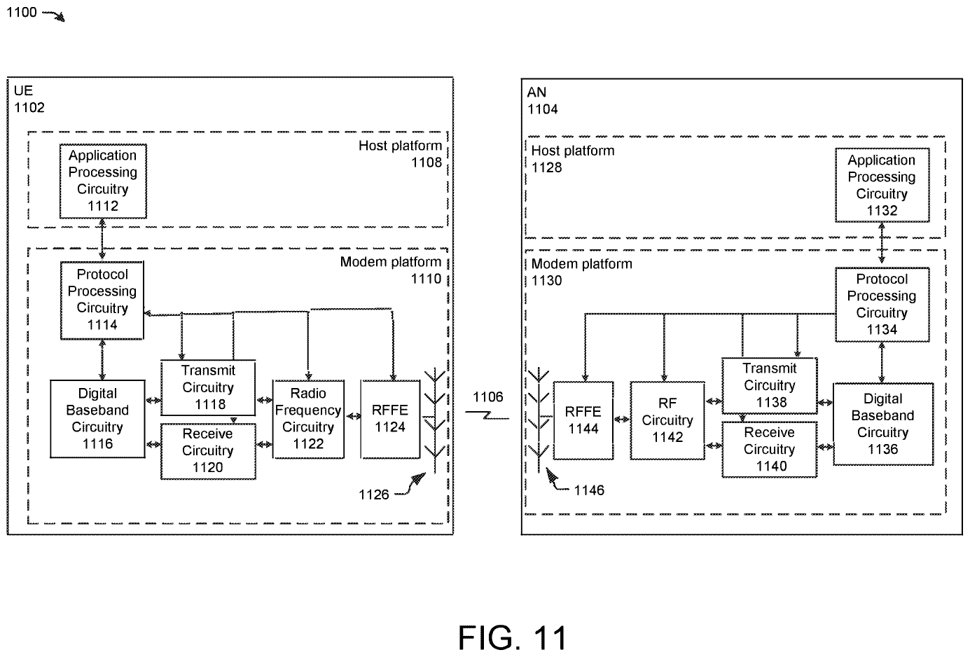

FIG. 11 schematically illustrates a wireless network 1100 in accordance with various embodiments. The wireless network 1100 may include a UE 1102 in wireless communication with an AN 1104. The UE 1102 and AN 1104 may be similar to, and substantially interchangeable with, like-named components described with respect to FIG. 10.

The UE 1102 may be communicatively coupled with the AN 1104 via connection 1106. The connection 1106 is illustrated as an air interface to enable communicative coupling, and can be consistent with cellular communications protocols such as an LTE protocol or a 5G NR protocol operating at mmWave or sub-6 GHZ frequencies.

The UE 1102 may include a host platform 1108 coupled with a modem platform 1110. The host platform 1108 may include application processing circuitry 1112, which may be coupled with protocol processing circuitry 1114 of the modem platform 1110. The application processing circuitry 1112 may run various applications for the UE 1102 that source/sink application data. The application processing circuitry 1112 may further implement one or more layer operations to transmit/receive application data to/from a data network. These layer operations may include transport (for example UDP) and Internet (for example, IP) operations

The protocol processing circuitry 1114 may implement one or more of layer operations to facilitate transmission or reception of data over the connection 1106. The layer operations implemented by the protocol processing circuitry 1114 may include, for example, MAC, RLC, PDCP, RRC and NAS operations.

The modem platform 1110 may further include digital baseband circuitry 1116 that may implement one or more layer operations that are “below” layer operations performed by the protocol processing circuitry 1114 in a network protocol stack. These operations may include, for example, PHY operations including one or more of HARQ acknowledgement (ACK) functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1110 may further include transmit circuitry 1118, receive circuitry 1120, RF circuitry 1122, and RF front end (RFFE) 1124, which may include or connect to one or more antenna panels 1126. Briefly, the transmit circuitry 1118 may include a digital-to-analog converter, mixer, intermediate frequency (IF) components, etc.; the receive circuitry 1120 may include an analog-to-digital converter, mixer, IF components, etc.; the RF circuitry 1122 may include a low-noise amplifier, a power amplifier, power tracking components, etc.; RFFE 1124 may include filters (for example, surface/bulk acoustic wave filters), switches, antenna tuners, beamforming components (for example, phase-array antenna components), etc.

In some embodiments, the protocol processing circuitry 1114 may include one or more instances of control circuitry (not shown) to provide control functions for the transmit/receive components.

A UE 1102 reception may be established by and via the antenna panels 1126, RFFE 1124, RF circuitry 1122, receive circuitry 1120, digital baseband circuitry 1116, and protocol processing circuitry 1114. In some embodiments, the antenna panels 1126 may receive a transmission from the AN 1104 by receive-beamforming signals received by a plurality of antennas/antenna elements of the one or more antenna panels 1126.

A UE 1102 transmission may be established by and via the protocol processing circuitry 1114, digital baseband circuitry 1116, transmit circuitry 1118, RF circuitry 1122, RFFE 1124, and antenna panels 1126. In some embodiments, the transmit components of the UE 1104 may apply a spatial filter to the data to be transmitted to form a transmit beam emitted by the antenna elements of the antenna panels 1126.

Similar to the UE 1102, the AN 1104 may include a host platform 1128 coupled with a modem platform 1130. The host platform 1128 may include application processing circuitry 1132 coupled with protocol processing circuitry 1134 of the modem platform 1130. The modem platform may further include digital baseband circuitry 1136, transmit circuitry 1138, receive circuitry 1140, RF circuitry 1142, RFFE circuitry 1144, and antenna panels 1146. The components of the AN 1104 may be similar to and substantially interchangeable with like-named components of the UE 1102. In addition to performing data transmission/reception as described above, the components of the AN 1108 may perform various logical functions that include, for example, RNC functions such as radio bearer management, uplink and downlink dynamic radio resource management, and data packet scheduling.

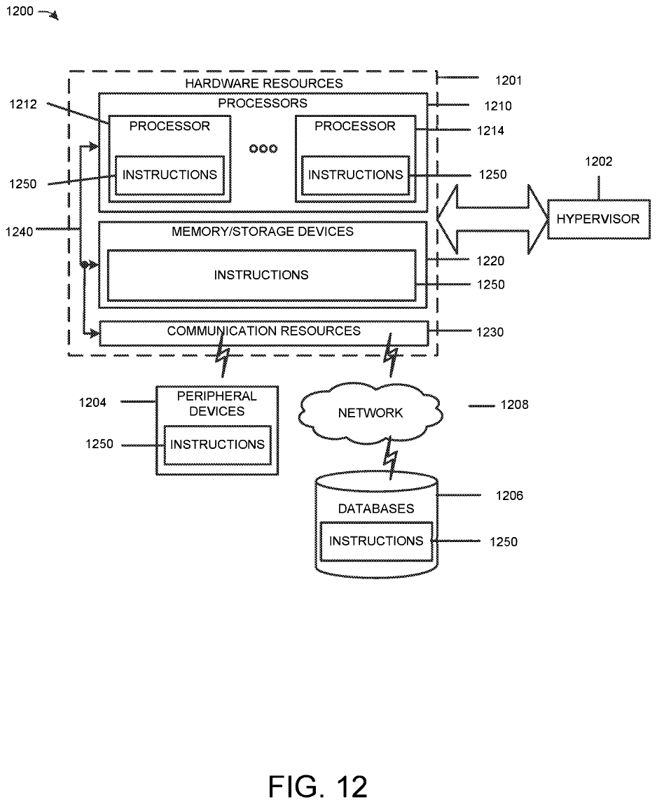

FIG. 12 illustrates components of a computing device 1200 according to some example embodiments, able to read instructions from a machine-readable or computer-readable medium (e.g., a non-transitory machine-readable storage medium) and perform any one or more of the methodologies discussed herein. Specifically, FIG. 12 shows a diagrammatic representation of hardware resources 1201 including one or more processors (or processor cores) 1210, one or more memory/storage devices 1220, and one or more communication resources 1230, each of which may be communicatively coupled via a bus 1240 or other interface circuitry. For embodiments where node virtualization (e.g., NFV) is utilized, a hypervisor 1202 may be executed to provide an execution environment for one or more network slices/sub-slices to utilize the hardware resources 1201.

The processors 1210 include, for example, processor 1212 and processor 1214. The processors 1210 may be, for example, a central processing unit (CPU), reduced instruction set computing (RISC) processors, Acorn RISC Machine (ARM) processors, complex instruction set computing (CISC) processors, graphics processing units (GPUs), one or more Digital Signal Processors (DSPs) such as a baseband processor, Application-Specific Integrated Circuits (ASICs), an Field-Programmable Gate Array (FPGA), a radio-frequency integrated circuit (RFIC), one or more microprocessors or controllers, another processor (including those discussed herein), or any suitable combination thereof. In some implementations, the processor circuitry 1210 may include one or more hardware accelerators, which may be microprocessors, programmable processing devices (e.g., FPGA, complex programmable logic devices (CPLDs), etc.), or the like.

The memory/storage devices 1220 may include main memory, disk storage, or any suitable combination thereof.

The communication resources 1230 may include interconnection or network interface controllers, components, or other suitable devices to communicate with one or more peripheral devices 1204 or one or more databases 1206 or other network elements via a network 1208. For example, the communication resources 1230 may include wired communication components (e.g., for coupling via USB, Ethernet, Ethernet, Ethernet over GRE Tunnels, Ethernet over Multiprotocol Label Switching (MPLS), Ethernet over USB, Controller Area Network (CAN), Local Interconnect Network (LIN), DeviceNet, ControlNet, Data Highway+, PROFIBUS, or PROFINET, among many others), cellular communication components, NFC components, Bluetooth® (or Bluetooth® Low Energy) components, WiFi® components, and other communication components. Network connectivity may be provided to/from the computing device 1200 via the communication resources 1230 using a physical connection, which may be electrical (e.g., a “copper interconnect”) or optical. The physical connection also includes suitable input connectors (e.g., ports, receptacles, sockets, etc.) and output connectors (e.g., plugs, pins, etc.). The communication resources 1230 may include one or more dedicated processors and/or FPGAs to communicate using one or more of the aforementioned network interface protocols.

Instructions 1250 may comprise software, a program, an application, an applet, an app, or other executable code for causing at least any of the processors 1210 to perform any one or more of the methodologies discussed herein. The instructions 1250 may reside, completely or partially, within at least one of the processors 1210 (e.g., within the processor's cache memory), the memory/storage devices 1220, or any suitable combination thereof. Furthermore, any portion of the instructions 1250 may be transferred to the hardware resources 1201 from any combination of the peripheral devices 1204 or the databases 1206. Accordingly, the memory of processors 1210, the memory/storage devices 1220, the peripheral devices 1204, and the databases 1206 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Additional examples of the presently described embodiments include the following, non-limiting implementations. Each of the following non-limiting examples may stand on its own or may be combined in any permutation or combination with any one or more of the other examples provided below or throughout the present disclosure.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below.

The following examples pertain to further embodiments.

Example 1 may include an apparatus comprising generate and map sensing modulated symbols to time and frequency resource elements (REs) of an Orthogonal Frequency Division Multiplexing (OFDM) resource grid, following a supported configurations of fifth generation (5G) NR Downlink (DL) Positioning Reference Signal (PRS), or 5G NR Uplink (UL) PRS based on a 5G NR Sounding Reference Signal (SRS), respectively, in which one or more sensing block durations are defined related to durations of one or more PRS resource sets which are dependent on repetition parameters and a number of resources within each PRS resource set; and transmit the modulated symbols in time and frequency resources.

Example 2 may include the apparatus of example 1 and/or some other example herein, wherein a frequency domain comb structure may be used between two downlink (DL) PRS resource sets or two uplink (UL) PRS resource sets transmitted by a same entity over a same OFDM time domain.

Example 3 may include the apparatus of example 1 and/or some other example herein, wherein a configuration of a DL PRS set supports configuring at least one of: two sets of values for {repetition gap, repetition factor}, a parameter indicating the relative offset between a starting of the two sets of repetitions, two values for the repetition factor, one indicating the maximum value to be used for sensing, and the other indicating the maximum value to be used for localization (positioning) of UEs, multiple PRS resources to use the same OFDM symbols and the same frequency resources, or using cyclic shifts in time domain or frequency domain of a generated sequence over these resources, where the number and a size of cyclic shift windows may be configured in relation to a numerology and a frequency domain comb-size and any prior information about a sensing environment.

Example 4 may include the apparatus of example 1 and/or some other example herein, wherein a configuration of a UL PRS set also supports configuring at least one of: more than one values for a periodicity, a parameter indicating the relative offset between a starting of periodicities, a duration parameter indicating how long a periodic occurrences of UL-PRS resource sets continues for, or multiple PRS resources to use the same OFDM symbols and the same frequency resources, or using cyclic shifts in time domain or frequency domain of a generated sequence over these resources, where the number and a size of cyclic shift windows may be configured in relation to a numerology and a frequency domain comb-size and any prior information about a sensing environment.

Example 5 may include the apparatus of example 1 and/or some other example herein, wherein the configuration of a DL PRS or a UL PRS supports configuring Quasi-Co-Location (QCL) relations between multiple resource sets or between resources in multiple resource sets.

Example 6 may include the apparatus of example 5 and/or some other example herein, wherein the configuration of the DL PRS or the UL PRS support configuring PRS repetition gap in granularity of half-slot, where a repetition factor indicates a number of half-slots that it repeats.

Example 7 may include the apparatus of example 5 and/or some other example herein, wherein the configuration of the DL PRS or the UL PRS support configuring PRS set to span over a first half of a slot and allows for configuring a repetition a gap of zero, in number of half-slots or slots.

Example 8 may include the apparatus of example 5 and/or some other example herein, wherein one or more of DL PRS resource or DL PRS resource set, or UL-PRS resource or UL-PRS resource set configurations are configured or overridden through Downlink Control Information (DCI) signaling indication or via MAC Control Element (CE).

Example 9 may include the apparatus of example 8 and/or some other example herein, wherein the configuration of the DL PRS or the UL PRS support configuring multiple beam directions in a same PRS resource by configuring cyclic shift values such that within a same PRS resource, different directions are multiplexed in a delay domain.

Example 10 may include a computer-readable medium storing computer-executable instructions which when executed by one or more processors result in performing operations comprising: generating and map sensing modulated symbols to time and frequency resource elements (REs) of an Orthogonal Frequency Division Multiplexing (OFDM) resource grid, following a supported configurations of fifth generation (5G) NR Downlink (DL) Positioning Reference Signal (PRS), or 5G NR Uplink (UL) PRS based on a 5G NR Sounding Reference Signal (SRS), respectively, in which one or more sensing block durations are defined related to durations of one or more PRS resource sets which are dependent on repetition parameters and a number of resources within each PRS resource set; and transmitting the modulated symbols in time and frequency resources.

Example 11 may include the computer-readable medium of example 10 and/or some other example herein, wherein a frequency domain comb structure may be used between two downlink (DL) PRS resource sets or two uplink (UL) PRS resource sets transmitted by a same entity over a same OFDM time domain.

Example 12 may include the computer-readable medium of example 10 and/or some other example herein, wherein a configuration of a DL PRS set supports configuring at least one of: two sets of values for {repetition gap, repetition factor}, a parameter indicating the relative offset between a starting of the two sets of repetitions, two values for the repetition factor, one indicating the maximum value to be used for sensing, and the other indicating the maximum value to be used for localization (positioning) of UEs, multiple PRS resources to use the same OFDM symbols and the same frequency resources, or using cyclic shifts in time domain or frequency domain of a generated sequence over these resources, where the number and a size of cyclic shift windows may be configured in relation to a numerology and a frequency domain comb-size and any prior information about a sensing environment.

Example 13 may include the computer-readable medium of example 10 and/or some other example herein, wherein a configuration of a UL PRS set also supports configuring at least one of: more than one values for a periodicity, a parameter indicating the relative offset between a starting of periodicities, a duration parameter indicating how long a periodic occurrences of UL-PRS resource sets continues for, or multiple PRS resources to use the same OFDM symbols and the same frequency resources, or using cyclic shifts in time domain or frequency domain of a generated sequence over these resources, where the number and a size of cyclic shift windows may be configured in relation to a numerology and a frequency domain comb-size and any prior information about a sensing environment.

Example 14 may include the computer-readable medium of example 10 and/or some other example herein, wherein the configuration of a DL PRS or a UL PRS supports configuring Quasi-Co-Location (QCL) relations between multiple resource sets or between resources in multiple resource sets.

Example 15 may include the computer-readable medium of example 14 and/or some other example herein, wherein the configuration of the DL PRS or the UL PRS support configuring PRS repetition gap in granularity of half-slot, where a repetition factor indicates a number of half-slots that it repeats.

Example 16 may include the computer-readable medium of example 14 and/or some other example herein, wherein the configuration of the DL PRS or the UL PRS support configuring PRS set to span over a first half of a slot and allows for configuring a repetition a gap of zero, in number of half-slots or slots.

Example 17 may include the computer-readable medium of example 14 and/or some other example herein, wherein one or more of DL PRS resource or DL PRS resource set, or UL-PRS resource or UL-PRS resource set configurations are configured or overridden through Downlink Control Information (DCI) signaling indication or via MAC Control Element (CE).

Example 18 may include the computer-readable medium of example 17 and/or some other example herein, wherein the configuration of the DL PRS or the UL PRS support configuring multiple beam directions in a same PRS resource by configuring cyclic shift values such that within a same PRS resource, different directions are multiplexed in a delay domain.

Example 19 may include a method comprising: generating, by one or more processors, and map sensing modulated symbols to time and frequency resource elements (REs) of an Orthogonal Frequency Division Multiplexing (OFDM) resource grid, following a supported configurations of fifth generation (5G) NR Downlink (DL) Positioning Reference Signal (PRS), or 5G NR Uplink (UL) PRS based on a 5G NR Sounding Reference Signal (SRS), respectively, in which one or more sensing block durations are defined related to durations of one or more PRS resource sets which are dependent on repetition parameters and a number of resources within each PRS resource set; and transmitting the modulated symbols in time and frequency resources.

Example 20 may include the method of example 19 and/or some other example herein, wherein a frequency domain comb structure may be used between two downlink (DL) PRS resource sets or two uplink (UL) PRS resource sets transmitted by a same entity over a same OFDM time domain.

Example 21 may include the method of example 19 and/or some other example herein, wherein a configuration of a DL PRS set supports configuring at least one of: two sets of values for {repetition gap, repetition factor}, a parameter indicating the relative offset between a starting of the two sets of repetitions, two values for the repetition factor, one indicating the maximum value to be used for sensing, and the other indicating the maximum value to be used for localization (positioning) of UEs, multiple PRS resources to use the same OFDM symbols and the same frequency resources, or using cyclic shifts in time domain or frequency domain of a generated sequence over these resources, where the number and a size of cyclic shift windows may be configured in relation to a numerology and a frequency domain comb-size and any prior information about a sensing environment.

Example 22 may include the method of example 19 and/or some other example herein, wherein a configuration of a UL PRS set also supports configuring at least one of: more than one values for a periodicity, a parameter indicating the relative offset between a starting of periodicities, a duration parameter indicating how long a periodic occurrences of UL-PRS resource sets continues for, or multiple PRS resources to use the same OFDM symbols and the same frequency resources, or using cyclic shifts in time domain or frequency domain of a generated sequence over these resources, where the number and a size of cyclic shift windows may be configured in relation to a numerology and a frequency domain comb-size and any prior information about a sensing environment.

Example 23 may include the method of example 19 and/or some other example herein, wherein the configuration of a DL PRS or a UL PRS supports configuring Quasi-Co-Location (QCL) relations between multiple resource sets or between resources in multiple resource sets.

Example 24 may include the method of example 23 and/or some other example herein, wherein the configuration of the DL PRS or the UL PRS support configuring PRS repetition gap in granularity of half-slot, where a repetition factor indicates a number of half-slots that it repeats.

Example 25 may include the method of example 23 and/or some other example herein, wherein the configuration of the DL PRS or the UL PRS support configuring PRS set to span over a first half of a slot and allows for configuring a repetition a gap of zero, in number of half-slots or slots.

Example 26 may include the method of example 23 and/or some other example herein, wherein one or more of DL PRS resource or DL PRS resource set, or UL-PRS resource or UL-PRS resource set configurations are configured or overridden through Downlink Control Information (DCI) signaling indication or via MAC Control Element (CE).

Example 27 may include the method of example 26 and/or some other example herein, wherein the configuration of the DL PRS or the UL PRS support configuring multiple beam directions in a same PRS resource by configuring cyclic shift values such that within a same PRS resource, different directions are multiplexed in a delay domain.

Example 28 may include an apparatus comprising means for: generating and map sensing modulated symbols to time and frequency resource elements (REs) of an Orthogonal Frequency Division Multiplexing (OFDM) resource grid, following a supported configurations of fifth generation (5G) NR Downlink (DL) Positioning Reference Signal (PRS), or 5G NR Uplink (UL) PRS based on a 5G NR Sounding Reference Signal (SRS), respectively, in which one or more sensing block durations are defined related to durations of one or more PRS resource sets which are dependent on repetition parameters and a number of resources within each PRS resource set; and transmitting the modulated symbols in time and frequency resources.

Example 29 may include the apparatus of example 28 and/or some other example herein, wherein a frequency domain comb structure may be used between two downlink (DL) PRS resource sets or two uplink (UL) PRS resource sets transmitted by a same entity over a same OFDM time domain.

Example 30 may include the apparatus of example 28 and/or some other example herein, wherein a configuration of a DL PRS set supports configuring at least one of: two sets of values for {repetition gap, repetition factor}, a parameter indicating the relative offset between a starting of the two sets of repetitions, two values for the repetition factor, one indicating the maximum value to be used for sensing, and the other indicating the maximum value to be used for localization (positioning) of UEs, multiple PRS resources to use the same OFDM symbols and the same frequency resources, or using cyclic shifts in time domain or frequency domain of a generated sequence over these resources, where the number and a size of cyclic shift windows may be configured in relation to a numerology and a frequency domain comb-size and any prior information about a sensing environment.

Example 31 may include the apparatus of example 28 and/or some other example herein, wherein a configuration of a UL PRS set also supports configuring at least one of: more than one values for a periodicity, a parameter indicating the relative offset between a starting of periodicities, a duration parameter indicating how long a periodic occurrences of UL-PRS resource sets continues for, or multiple PRS resources to use the same OFDM symbols and the same frequency resources, or using cyclic shifts in time domain or frequency domain of a generated sequence over these resources, where the number and a size of cyclic shift windows may be configured in relation to a numerology and a frequency domain comb-size and any prior information about a sensing environment.

Example 32 may include the apparatus of example 28 and/or some other example herein, wherein the configuration of a DL PRS or a UL PRS supports configuring Quasi-Co-Location (QCL) relations between multiple resource sets or between resources in multiple resource sets.

Example 33 may include the apparatus of example 32 and/or some other example herein, wherein the configuration of the DL PRS or the UL PRS support configuring PRS repetition gap in granularity of half-slot, where a repetition factor indicates a number of half-slots that it repeats.

Example 34 may include the apparatus of example 32 and/or some other example herein, wherein the configuration of the DL PRS or the UL PRS support configuring PRS set to span over a first half of a slot and allows for configuring a repetition a gap of zero, in number of half-slots or slots.

Example 35 may include the apparatus of example 32 and/or some other example herein, wherein one or more of DL PRS resource or DL PRS resource set, or UL-PRS resource or UL-PRS resource set configurations are configured or overridden through Downlink Control Information (DCI) signaling indication or via MAC Control Element (CE).

Example 36 may include the apparatus of example 35 and/or some other example herein, wherein the configuration of the DL PRS or the UL PRS support configuring multiple beam directions in a same PRS resource by configuring cyclic shift values such that within a same PRS resource, different directions are multiplexed in a delay domain.

Example 37 may include an apparatus comprising means for performing any of the methods of examples 1-36.

Example 38 may include a network node comprising a communication interface and processing circuitry connected thereto and configured to perform the methods of examples 1-36.

Example 39 may include an apparatus comprising means to perform one or more elements of a method described in or related to any of examples 1-36, or any other method or process described herein.

Example 40 may include one or more non-transitory computer-readable media comprising instructions to cause an electronic device, upon execution of the instructions by one or more processors of the electronic device, to perform one or more elements of a method described in or related to any of examples 1-36, or any other method or process described herein.

Example 41 may include an apparatus comprising logic, modules, or circuitry to perform one or more elements of a method described in or related to any of examples 1-36, or any other method or process described herein.

Example 42 may include a method, technique, or process as described in or related to any of examples 1-36, or portions or parts thereof.

Example 43 may include an apparatus comprising: one or more processors and one or more computer-readable media comprising instructions that, when executed by the one or more processors, cause the one or more processors to perform the method, techniques, or process as described in or related to any of examples 1-36, or portions thereof.

Example 44 may include a signal as described in or related to any of examples 1-36, or portions or parts thereof.

Example 45 may include a datagram, packet, frame, segment, protocol data unit (PDU), or message as described in or related to any of examples 1-36, or portions or parts thereof, or otherwise described in the present disclosure.

Example 46 may include a signal encoded with data as described in or related to any of examples 1-36, or portions or parts thereof, or otherwise described in the present disclosure.

Example 47 may include a signal encoded with a datagram, packet, frame, segment, protocol data unit (PDU), or message as described in or related to any of examples 1-36, or portions or parts thereof, or otherwise described in the present disclosure.

Example 48 may include an electromagnetic signal carrying computer-readable instructions, wherein execution of the computer-readable instructions by one or more processors is to cause the one or more processors to perform the method, techniques, or process as described in or related to any of examples 1-36, or portions thereof.

Example 49 may include a computer program comprising instructions, wherein execution of the program by a processing element is to cause the processing element to carry out the method, techniques, or process as described in or related to any of examples 1-36, or portions thereof.

Example 50 may include a signal in a wireless network as shown and described herein.

Example 51 may include a method of communicating in a wireless network as shown and described herein.

Example 52 may include a system for providing wireless communication as shown and described herein.

Example 53 may include a device for providing wireless communication as shown and described herein.

An example implementation is an edge computing system, including respective edge processing devices and nodes to invoke or perform the operations of the examples above, or other subject matter described herein. Another example implementation is a client endpoint node, operable to invoke or perform the operations of the examples above, or other subject matter described herein. Another example implementation is an aggregation node, network hub node, gateway node, or core data processing node, within or coupled to an edge computing system, operable to invoke or perform the operations of the examples above, or other subject matter described herein. Another example implementation is an access point, base station, road-side unit, street-side unit, or on-premise unit, within or coupled to an edge computing system, operable to invoke or perform the operations of the examples above, or other subject matter described herein. Another example implementation is an edge provisioning node, service orchestration node, application orchestration node, or multi-tenant management node, within or coupled to an edge computing system, operable to invoke or perform the operations of the examples above, or other subject matter described herein. Another example implementation is an edge node operating an edge provisioning service, application or service orchestration service, virtual machine deployment, container deployment, function deployment, and compute management, within or coupled to an edge computing system, operable to invoke or perform the operations of the examples above, or other subject matter described herein. Another example implementation is an edge computing system operable as an edge mesh, as an edge mesh with side car loading, or with mesh-to-mesh communications, operable to invoke or perform the operations of the examples above, or other subject matter described herein. Another example implementation is an edge computing system including aspects of network functions, acceleration functions, acceleration hardware, storage hardware, or computation hardware resources, operable to invoke or perform the use cases discussed herein, with use of the examples above, or other subject matter described herein. Another example implementation is an edge computing system adapted for supporting client mobility, vehicle-to-vehicle (V2V), vehicle-to-everything (V2X), or vehicle-to-infrastructure (V2I) scenarios, and optionally operating according to ETSI MEC specifications, operable to invoke or perform the use cases discussed herein, with use of the examples above, or other subject matter described herein. Another example implementation is an edge computing system adapted for mobile wireless communications, including configurations according to an 3GPP 4G/LTE or 5G network capabilities, operable to invoke or perform the use cases discussed herein, with use of the examples above, or other subject matter described herein. Another example implementation is a computing system adapted for network communications, including configurations according to an O-RAN capabilities, operable to invoke or perform the use cases discussed herein, with use of the examples above, or other subject matter described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### TERMINOLOGY

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” which may each refer to one or more of the same or different embodiments. Furthermore, the terms “comprising,” “including,” “having,” and the like, as used with respect to embodiments of the present disclosure, are synonymous.

The terms “coupled,” “communicatively coupled.” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “memory” and/or “memory circuitry” as used herein refers to one or more hardware devices for storing data, including RAM, MRAM, PRAM, DRAM, and/or SDRAM, core memory, ROM, magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource. The term “element” refers to a unit that is indivisible at a given level of abstraction and has a clearly defined boundary, wherein an element may be any type of entity including, for example, one or more devices, systems, controllers, network elements, modules, etc., or combinations thereof. The term “device” refers to a physical entity embedded inside, or attached to, another physical entity in its vicinity, with capabilities to convey digital information from or to that physical entity. The term “entity” refers to a distinct component of an architecture or device, or information transferred as a payload. The term “controller” refers to an element or entity that has the capability to affect a physical entity, such as by changing its state or causing the physical entity to move.

The term “cloud computing” or “cloud” refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like). The term “computing resource” or simply “resource” refers to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g., channels/links, ports, network sockets, etc.), operating systems, virtual machines (VMs), software/applications, computer files, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable. As used herein, the term “cloud service provider” (or CSP) indicates an organization which operates typically large-scale “cloud” resources comprised of centralized, regional, and edge data centers (e.g., as used in the context of the public cloud). In other examples, a CSP may also be referred to as a Cloud Service Operator (CSO). References to “cloud computing” generally refer to computing resources and services offered by a CSP or a CSO, at remote locations with at least some increased latency, distance, or constraints relative to edge computing.

As used herein, the term “data center” refers to a purpose-designed structure that is intended to house multiple high-performance compute and data storage nodes such that a large amount of compute, data storage and network resources are present at a single location. This often entails specialized rack and enclosure systems, suitable heating, cooling, ventilation, security, fire suppression, and power delivery systems. The term may also refer to a compute and data storage node in some contexts. A data center may vary in scale between a centralized or cloud data center (e.g., largest), regional data center, and edge data center (e.g., smallest).

As used herein, the term “edge computing” refers to the implementation, coordination, and use of computing and resources at locations closer to the “edge” or collection of “edges” of a network. Deploying computing resources at the network's edge may reduce application and network latency, reduce network backhaul traffic and associated energy consumption, improve service capabilities, improve compliance with security or data privacy requirements (especially as compared to conventional cloud computing), and improve total cost of ownership). As used herein, the term “edge compute node” refers to a real-world, logical, or virtualized implementation of a compute-capable element in the form of a device, gateway, bridge, system or subsystem, component, whether operating in a server, client, endpoint, or peer mode, and whether located at an “edge” of an network or at a connected location further within the network. References to a “node” used herein are generally interchangeable with a “device”, “component”, and “sub-system”; however, references to an “edge computing system” or “edge computing network” generally refer to a distributed architecture, organization, or collection of multiple nodes and devices, and which is organized to accomplish or offer some aspect of services or resources in an edge computing setting.

Additionally or alternatively, the term “Edge Computing” refers to a concept, as described in [1], that enables operator and 3rd party services to be hosted close to the UE's access point of attachment, to achieve an efficient service delivery through the reduced end-to-end latency and load on the transport network. As used herein, the term “Edge Computing Service Provider” refers to a mobile network operator or a 3rd party service provider offering Edge Computing service. As used herein, the term “Edge Data Network” refers to a local Data Network (DN) that supports the architecture for enabling edge applications. As used herein, the term “Edge Hosting Environment” refers to an environment providing support required for Edge Application Server's execution. As used herein, the term “Application Server” refers to application software resident in the cloud performing the server function.

The term “Internet of Things” or “IoT” refers to a system of interrelated computing devices, mechanical and digital machines capable of transferring data with little or no human interaction, and may involve technologies such as real-time analytics, machine learning and/or AI, embedded systems, wireless sensor networks, control systems, automation (e.g., smarthome, smart building and/or smart city technologies), and the like. IoT devices are usually low-power devices without heavy compute or storage capabilities. “Edge IoT devices” may be any kind of IoT devices deployed at a network's edge.

As used herein, the term “cluster” refers to a set or grouping of entities as part of an edge computing system (or systems), in the form of physical entities (e.g., different computing systems, networks or network groups), logical entities (e.g., applications, functions, security constructs, containers), and the like. In some locations, a “cluster” is also referred to as a “group” or a “domain”. The membership of cluster may be modified or affected based on conditions or functions, including from dynamic or property-based membership, from network or system management scenarios, or from various example techniques discussed below which may add, modify, or remove an entity in a cluster. Clusters may also include or be associated with multiple layers, levels, or properties, including variations in security features and results based on such layers, levels, or properties.

The term “application” may refer to a complete and deployable package, environment to achieve a certain function in an operational environment. The term “AI/ML application” or the like may be an application that contains some AI/ML models and application-level descriptions. The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), decision tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

The terms “instantiate,” “instantiation,” and the like as used herein refers to the creation of an instance. An “instance” also refers to a concrete occurrence of an object, which may occur, for example, during execution of program code. The term “information element” refers to a structural element containing one or more fields. The term “field” refers to individual contents of an information element, or a data element that contains content. As used herein, a “database object”, “data structure”, or the like may refer to any representation of information that is in the form of an object, attribute-value pair (AVP), key-value pair (KVP), tuple, etc., and may include variables, data structures, functions, methods, classes, database records, database fields, database entities, associations between data and/or database entities (also referred to as a “relation”), blocks and links between blocks in block chain implementations, and/or the like.

An “information object,” as used herein, refers to a collection of structured data and/or any representation of information, and may include, for example electronic documents (or “documents”), database objects, data structures, files, audio data, video data, raw data, archive files, application packages, and/or any other like representation of information. The terms “electronic document” or “document,” may refer to a data structure, computer file, or resource used to record data, and includes various file types and/or data formats such as word processing documents, spreadsheets, slide presentations, multimedia items, webpage and/or source code documents, and/or the like. As examples, the information objects may include markup and/or source code documents such as HTML, XML, JSON, Apex®, CSS, JSP, MessagePack™, Apache® Thrift™, ASN.1, Google® Protocol Buffers (protobuf), or some other document(s)/format(s) such as those discussed herein. An information object may have both a logical and a physical structure. Physically, an information object comprises one or more units called entities. An entity is a unit of storage that contains content and is identified by a name. An entity may refer to other entities to cause their inclusion in the information object. An information object begins in a document entity, which is also referred to as a root element (or “root”). Logically, an information object comprises one or more declarations, elements, comments, character references, and processing instructions, all of which are indicated in the information object (e.g., using markup).

The term “data item” as used herein refers to an atomic state of a particular object with at least one specific property at a certain point in time. Such an object is usually identified by an object name or object identifier, and properties of such an object are usually defined as database objects (e.g., fields, records, etc.), object instances, or data elements (e.g., mark-up language elements/tags, etc.). Additionally or alternatively, the term “data item” as used herein may refer to data elements and/or content items, although these terms may refer to difference concepts. The term “data element” or “element” as used herein refers to a unit that is indivisible at a given level of abstraction and has a clearly defined boundary. A data element is a logical component of an information object (e.g., electronic document) that may begin with a start tag (e.g., “<element>”) and end with a matching end tag (e.g., “</element>”), or only has an empty element tag (e.g., “<element/>”). Any characters between the start tag and end tag, if any, are the element's content (referred to herein as “content items” or the like).

The content of an entity may include one or more content items, each of which has an associated datatype representation. A content item may include, for example, attribute values, character values, URIs, qualified names (qnames), parameters, and the like. A qname is a fully qualified name of an element, attribute, or identifier in an information object. A qname associates a URI of a namespace with a local name of an element, attribute, or identifier in that namespace. To make this association, the qname assigns a prefix to the local name that corresponds to its namespace. The qname comprises a URI of the namespace, the prefix, and the local name. Namespaces are used to provide uniquely named elements and attributes in information objects. Content items may include text content (e.g., “<element>content item</element>”), attributes (e.g., “<element attribute=“attributeValue”>”), and other elements referred to as “child elements” (e.g., “<element1><element2>content item</element2></element1>”). An “attribute” may refer to a markup construct including a name-value pair that exists within a start tag or empty element tag. Attributes contain data related to its element and/or control the element's behavior.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable. The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information. As used herein, the term “radio technology” refers to technology for wireless transmission and/or reception of electromagnetic radiation for information transfer. The term “radio access technology” or “RAT” refers to the technology used for the underlying physical connection to a radio based communication network. As used herein, the term “communication protocol” (either wired or wireless) refers to a set of standardized rules or instructions implemented by a communication device and/or system to communicate with other devices and/or systems, including instructions for packetizing/depacketizing data, modulating/demodulating signals, implementation of protocols stacks, and/or the like.

As used herein, the term “radio technology” refers to technology for wireless transmission and/or reception of electromagnetic radiation for information transfer. The term “radio access technology” or “RAT” refers to the technology used for the underlying physical connection to a radio based communication network. As used herein, the term “communication protocol” (either wired or wireless) refers to a set of standardized rules or instructions implemented by a communication device and/or system to communicate with other devices and/or systems, including instructions for packetizing/depacketizing data, modulating/demodulating signals, implementation of protocols stacks, and/or the like. Examples of wireless communications protocols may be used in various embodiments include a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology including, for example, 3GPP Fifth Generation (5G) or New Radio (NR), Universal Mobile Telecommunications System (UMTS), Freedom of Multimedia Access (FOMA), Long Term Evolution (LTE), LTE-Advanced (LTE Advanced), LTE Extra, LTE-A Pro, cdmaOne (2G), Code Division Multiple Access 2000 (CDMA 2000), Cellular Digital Packet Data (CDPD), Mobitex, Circuit Switched Data (CSD), High-Speed CSD (HSCSD), Universal Mobile Telecommunications System (UMTS), Wideband Code Division Multiple Access (W-CDM), High Speed Packet Access (HSPA), HSPA Plus (HSPA+), Time Division-Code Division Multiple Access (TD-CDMA), Time Division-Synchronous Code Division Multiple Access (TD-SCDMA), LTE LAA, MuLTEfire, UMTS Terrestrial Radio Access (UTRA), Evolved UTRA (E-UTRA), Evolution-Data Optimized or Evolution-Data Only (EV-DO), Advanced Mobile Phone System (AMPS), Digital AMPS (D-AMPS), Total Access Communication System/Extended Total Access Communication System (TACS/ETACS), Push-to-talk (PTT), Mobile Telephone System (MTS), Improved Mobile Telephone System (IMTS), Advanced Mobile Telephone System (AMTS), Cellular Digital Packet Data (CDPD), DataTAC, Integrated Digital Enhanced Network (iDEN), Personal Digital Cellular (PDC), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Bluetooth®, Bluetooth Low Energy (BLE), IEEE 802.15.4 based protocols (e.g., IPv6 over Low power Wireless Personal Area Networks (6LoWPAN), WirelessHART, MiWi, Thread, 802.11a, etc.) WiFi-direct, ANT/ANT+, ZigBee, Z-Wave, 3GPP device-to-device (D2D) or Proximity Services (ProSe), Universal Plug and Play (UPnP), Low-Power Wide-Area-Network (LPWAN), Long Range Wide Area Network (LoRA) or LoRaWAN™ developed by Semtech and the LoRa Alliance, Sigfox, Wireless Gigabit Alliance (WiGig) standard, Worldwide Interoperability for Microwave Access (WiMAX), mmWave standards in general (e.g., wireless systems operating at 10-300 GHz and above such as WiGig, IEEE 802.11ad, IEEE 802.11ay, etc.), V2X communication technologies (including 3GPP C-V2X), Dedicated Short Range Communications (DSRC) communication systems such as Intelligent-Transport-Systems (ITS) including the European ITS-G5, ITS-G5B, ITS-G5C, etc. In addition to the standards listed above, any number of satellite uplink technologies may be used for purposes of the present disclosure including, for example, radios compliant with standards issued by the International Telecommunication Union (ITU), or the European Telecommunications Standards Institute (ETSI), among others. The examples provided herein are thus understood as being applicable to various other communication technologies, both existing and not yet formulated.

The term “access network” refers to any network, using any combination of radio technologies, RATs, and/or communication protocols, used to connect user devices and service providers. In the context of WLANs, an “access network” is an IEEE 802 local area network (LAN) or metropolitan area network (MAN) between terminals and access routers connecting to provider services. The term “access router” refers to router that terminates a medium access control (MAC) service from terminals and forwards user traffic to information servers according to Internet Protocol (IP) addresses.

The term “SMTC” refers to an SSB-based measurement timing configuration configured by SSB-MeasurementTimingConfiguration. The term “SSB” refers to a synchronization signal/Physical Broadcast Channel (SS/PBCH) block, which includes a Primary Syncrhonization Signal (PSS), a Secondary Syncrhonization Signal (SSS), and a PBCH. The term “a “Primary Cell” refers to the MCG cell, operating on the primary frequency, in which the UE either performs the initial connection establishment procedure or initiates the connection re-establishment procedure. The term “Primary SCG Cell” refers to the SCG cell in which the UE performs random access when performing the Reconfiguration with Sync procedure for DC operation. The term “Secondary Cell” refers to a cell providing additional radio resources on top of a Special Cell for a UE configured with CA. The term “Secondary Cell Group” refers to the subset of serving cells comprising the PSCell and zero or more secondary cells for a UE configured with DC. The term “Serving Cell” refers to the primary cell for a UE in RRC_CONNECTED not configured with CA/DC there is only one serving cell comprising of the primary cell. The term “serving cell” or “serving cells” refers to the set of cells comprising the Special Cell(s) and all secondary cells for a UE in RRC_CONNECTED configured with CA. The term “Special Cell” refers to the PCell of the MCG or the PSCell of the SCG for DC operation; otherwise, the term “Special Cell” refers to the Pcell.

The term “A1 policy” refers to a type of declarative policies expressed using formal statements that enable the non-RT RIC function in the SMO to guide the near-RT RIC function, and hence the RAN, towards better fulfilment of the RAN intent.

The term “A1 Enrichment information” refers to information utilized by near-RT RIC that is collected or derived at SMO/non-RT RIC either from non-network data sources or from network functions themselves.

The term “A1-Policy Based Traffic Steering Process Mode” refers to an operational mode in which the Near-RT RIC is configured through A1 Policy to use Traffic Steering Actions to ensure a more specific notion of network performance (for example, applying to smaller groups of E2 Nodes and UEs in the RAN) than that which it ensures in the Background Traffic Steering.

The term “Background Traffic Steering Processing Mode” refers to an operational mode in which the Near-RT RIC is configured through O1 to use Traffic Steering Actions to ensure a general background network performance which applies broadly across E2 Nodes and UEs in the RAN.

The term “Baseline RAN Behavior” refers to the default RAN behavior as configured at the E2 Nodes by SMO

The term “E2” refers to an interface connecting the Near-RT RIC and one or more O-CU-CPs, one or more O-CU-UPs, one or more O-DUs, and one or more O-eNBs.

The term “E2 Node” refers to a logical node terminating E2 interface. In this version of the specification, ORAN nodes terminating E2 interface are: for NR access: O-CU-CP, O-CU-UP, O-DU or any combination; and for E-UTRA access: O-eNB.

The term “Intents”, in the context of O-RAN systems/implementations, refers to declarative policy to steer or guide the behavior of RAN functions, allowing the RAN function to calculate the optimal result to achieve stated objective.

The term “O-RAN non-real-time RAN Intelligent Controller” or “non-RT RIC” refers to a logical function that enables non-real-time control and optimization of RAN elements and resources, AI/ML workflow including model training and updates, and policy-based guidance of applications/features in Near-RT RIC.

The term “Near-RT RIC” or “O-RAN near-real-time RAN Intelligent Controller” refers to a logical function that enables near-real-time control and optimization of RAN elements and resources via fine-grained (e.g., UE basis, Cell basis) data collection and actions over E2 interface.

The term “O-RAN Central Unit” or “O-CU” refers to a logical node hosting RRC, SDAP and PDCP protocols.

The term “O-RAN Central Unit-Control Plane” or “O-CU-CP” refers to a logical node hosting the RRC and the control plane part of the PDCP protocol.

The term “O-RAN Central Unit-User Plane” or “O-CU-UP” refers to a logical node hosting the user plane part of the PDCP protocol and the SDAP protocol

The term “O-RAN Distributed Unit” or “O-DU” refers to a logical node hosting RLC/MAC/High-PHY layers based on a lower layer functional split.

The term “O-RAN eNB” or “O-eNB” refers to an eNB or ng-eNB that supports E2 interface.

The term “O-RAN Radio Unit” or “O-RU” refers to a logical node hosting Low-PHY layer and RF processing based on a lower layer functional split. This is similar to 3GPP's “TRP” or “RRH” but more specific in including the Low-PHY layer (FFT/iFFT, PRACH extraction).

The term “O1” refers to an interface between orchestration & management entities (Orchestration/NMS) and O-RAN managed elements, for operation and management, by which FCAPS management, Software management, File management and other similar functions shall be achieved.

The term “RAN UE Group” refers to an aggregations of UEs whose grouping is set in the E2 nodes through E2 procedures also based on the scope of A1 policies. These groups can then be the target of E2 CONTROL or POLICY messages.

The term “Traffic Steering Action” refers to the use of a mechanism to alter RAN behavior. Such actions include E2 procedures such as CONTROL and POLICY.

The term “Traffic Steering Inner Loop” refers to the part of the Traffic Steering processing, triggered by the arrival of periodic TS related KPM (Key Performance Measurement) from E2 Node, which includes UE grouping, setting additional data collection from the RAN, as well as selection and execution of one or more optimization actions to enforce Traffic Steering policies.

The term “Traffic Steering Outer Loop” refers to the part of the Traffic Steering processing, triggered by the near-RT RIC setting up or updating Traffic Steering aware resource optimization procedure based on information from A1 Policy setup or update, A1 Enrichment Information (EI) and/or outcome of Near-RT RIC evaluation, which includes the initial configuration (preconditions) and injection of related A1 policies, Triggering conditions for TS changes.

The term “Traffic Steering Processing Mode” refers to an operational mode in which either the RAN or the Near-RT RIC is configured to ensure a particular network performance. This performance includes such aspects as cell load and throughput, and can apply differently to different E2 nodes and UEs. Throughout this process, Traffic Steering Actions are used to fulfill the requirements of this configuration.

The term “Traffic Steering Target” refers to the intended performance result that is desired from the network, which is configured to Near-RT RIC over O1.

### ABBREVIATIONS

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

TABLE 1
Abbreviations:

| | |
|---|---|
| 3GPP | Third Generation Partnership Project |
| 4G | Fourth Generation |
| 5G | Fifth Generation |
| 5GC | 5G Core network |
| AC | Application Client |
| ACK | Acknowledgement |
| ACID | Application Client Identification |
| AF | Application Function |
| AM | Acknowledged Mode |
| AMBR | Aggregate Maximum Bit Rate |
| AMF | Access and Mobility Management Function |
| AN | Access Network |
| ANR | Automatic Neighbour Relation |
| AP | Application Protocol, Antenna Port, Access Point |
| API | Application Programming Interface |
| APN | Access Point Name |
| ARP | Allocation and Retention Priority |
| ARQ | Automatic Repeat Request |
| AS | Access Stratum |
| ASP | Application Service Provider |
| ASN.1 | Abstract Syntax Notation One |
| AUSF | Authentication Server Function |
| AWGN | Additive White Gaussian Noise |
| BAP | Backhaul Adaptation Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access Server |
| BSS | Business Support System |
| BS | Base Station |
| BSR | Buffer Status Report |
| BW | Bandwidth |
| BWP | Bandwidth Part |
| C-RNTI | Cell Radio Network Temporary Identity |
| CA | Carrier Aggregation, Certification Authority |
| CAPEX | CAPital Expenditure |
| CBRA | Contention Based Random Access |
| CC | Component Carrier, Country Code, Cryptographic Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple Access |
| CFRA | Contention Free Random Access |
| CG | Cell Group |
| CGF | Charging Gateway Function |
| CHF | Charging Function |
| CI | Cell Identity |
| CID | Cell-ID (e.g., positioning method) |
| CIM | Common Information Model |
| CIR | Carrier to Interference Ratio |
| CK | Cipher Key |
| CM | Connection Management, Conditional Mandatory |
| CMAS | Commercial Mobile Alert Service |
| CMD | Command |
| CMS | Cloud Management System |
| CO | Conditional Optional |
| COMP | Coordinated Multi-Point |
| CORESET | Control Resource Set |
| COTS | Commercial Off-The-Shelf |
| CP | Control Plane, Cyclic Prefix, Connection Point |
| CPD | Connection Point Descriptor |
| CPE | Customer Premise Equipment |
| CPICH | Common Pilot Channel |
| CQI | Channel Quality Indicator |
| CPU | CSI processing unit, Central Processing Unit |
| C/R | Command/Response field bit |
| CRAN | Cloud Radio Access Network, Cloud RAN |
| CRB | Common Resource Block |
| CRC | Cyclic Redundancy Check |
| CRI | Channel-State Information Resource Indicator, CSI-RS Resource Indicator |
| C-RNTI | Cell RNTI |
| CS | Circuit Switched |
| CSAR | Cloud Service Archive |
| CSI | Channel-State Information |
| CSI-IM | CSI Interference Measurement |
| CSI-RS | CSI Reference Signal |
| CSI-RSRP | CSI reference signal received power |
| CSI-RSRQ | CSI reference signal received quality |
| CSI-SINR | CSI signal-to-noise and interference ratio |
| CSMA | Carrier Sense Multiple Access |
| CSMA/CA | CSMA with collision avoidance |
| CSS | Common Search Space, Cell-specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, Direct Current |
| DCI | Downlink Control Information |
| DF | Deployment Flavour |
| DL | Downlink |
| DMTF | Distributed Management Task Force |
| DPDK | Data Plane Development Kit |
| DM-RS, | DMRS Demodulation Reference Signal |
| DN | Data network |
| DNN | Data Network Name |
| DNAI | Data Network Access Identifier |
| DRB | Data Radio Bearer |
| DRS | Discovery Reference Signal |
| DRX | Discontinuous Reception |
| DSL | Domain Specific Language. Digital Subscriber Line |
| DSLAM | DSL Access Multiplexer |
| DwPTS | Downlink Pilot Time Slot |
| E-LAN | Ethernet Local Area Network |
| E2E | End-to-End |
| ECCA | extended clear channel assessment, extended CCA |
| ECCE | Enhanced Control Channel Element, Enhanced CCE |
| ED | Energy Detection |
| EDGE | Enhanced Datarates for GSM Evolution (GSM Evolution) |
| EAS | Edge Application Server |
| EASID | Edge Application Server Identification |
| ECS | Edge Configuration Server |
| ECSP | Edge Computing Service Provider |
| EDN | Edge Data Network |
| EEC | Edge Enabler Client |
| EECID | Edge Enabler Client Identification |
| EES | Edge Enabler Server |
| EESID | Edge Enabler Server Identification |
| EHE | Edge Hosting Environment |
| EGMF | Exposure Governance tableManagement Function |
| EGPRS | Enhanced GPRS |
| EIR | Equipment Identity Register |
| eLAA | enhanced Licensed Assisted Access, enhanced LAA |
| EM | Element Manager |
| eMBB | Enhanced Mobile Broadband |
| EMS | Element Management System |
| eNB | evolved NodeB, E-UTRAN Node B |
| EN-DC | E-UTRA-NR Dual Connectivity |
| EPC | Evolved Packet Core |
| EPDCCH | enhanced PDCCH, enhanced Physical Downlink Control Cannel |
| EPRE | Energy per resource element |
| EPS | Evolved Packet System |
| EREG | enhanced REG, enhanced resource element groups |
| ETSI | European Telecommunications Standards Institute |
| ETWS | Earthquake and Tsunami Warning System |
| eUICC | embedded UICC, embedded Universal Integrated Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control CHannel |
| FACCH/F | Fast Associated Control Channel/Full rate |
| FACCH/H | Fast Associated Control Channel/Half rate |
| FACH | Forward Access Channel |
| FAUSCH | Fast Uplink Signalling Channel |
| FB | Functional Block |
| FBI | Feedback Information |
| FCC | Federal Communications Commission |
| FCCH | Frequency Correction CHannel |
| FDD | Frequency Division Duplex |
| FDM | Frequency Division Multiplex |
| FDMA | Frequency Division Multiple Access |
| FE | Front End |
| FEC | Forward Error Correction |
| FFS | For Further Study |
| FFT | Fast Fourier Transformation |
| feLAA | further enhanced Licensed Assisted Access, further enhanced LAA |
| FN | Frame Number |
| FPGA | Field-Programmable Gate Array |
| FR | Frequency Range |
| FQDN | Fully Qualified Domain Name |
| G-RNTI | GERAN Radio Network Temporary Identity |
| GERAN | GSM EDGE RAN, GSM EDGE Radio Access Network |
| GGSN | Gateway GPRS Support Node |
| GLONASS | GLObal'naya NAvigatsionnaya Sputnikovaya Sistema |
| | (Engl.: Global Navigation Satellite System) |
| gNB | Next Generation NodeB |
| gNB-CU | gNB-centralized unit, Next Generation NodeB centralized unit |
| gNB-DU | gNB-distributed unit, Next Generation NodeB distributed unit |
| GNSS | Global Navigation Satellite System |
| GPRS | General Packet Radio Service |
| GPSI | Generic Public Subscription Identifier |
| GSM | Global System for Mobile Communications, Groupe Special Mobile |
| GTP | GPRS Tunneling Protocol |
| GTP-U | GPRS Tunnelling Protocol for User Plane |
| GTS | Go To Sleep Signal (related to WUS) |
| GUMMEI | Globally Unique MME Identifier |
| GUTI | Globally Unique Temporary UE Identity |
| HARQ | Hybrid ARQ, Hybrid Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile Network |
| HSDPA | High Speed Downlink Packet Access |
| HSN | Hopping Sequence Number |
| HSPA | High Speed Packet Access |
| HSS | Home Subscriber Server |
| HSUPA | High Speed Uplink Packet Access |
| HTTP | Hyper Text Transfer Protocol |
| HTTPS | Hyper Text Transfer Protocol Secure (https is http/1.1 over SSL, i.e. port 443) |
| I-Block | Information Block |
| ICCID | Integrated Circuit Card Identification |
| IAB | Integrated Access and Backhaul |
| ICIC | Inter-Cell Interference Coordination |
| ID | Identity, identifier |
| IDFT | Inverse Discrete Fourier Transform |
| IE | Information element |
| IBE | In-Band Emission |
| IEEE | Institute of Electrical and Electronics Engineers |
| IEI | Information Element Identifier |
| IEIDL | Information Element Identifier Data Length |
| IETF | Internet Engineering Task Force |
| IF | Infrastructure |
| IM | Interference Measurement, Intermodulation, IP Multimedia |
| IMC | IMS Credentials |
| IMEI | International Mobile Equipment Identity |
| IMGI | International mobile group identity |
| IMPI | IP Multimedia Private Identity |
| IMPU | IP Multimedia PUblic identity |
| IMS | IP Multimedia Subsystem |
| IMSI | International Mobile Subscriber Identity |
| IOT | Internet of Things |
| IP | Internet Protocol |
| Ipsec | IP Security, Internet Protocol Security |
| IP-CAN | IP-Connectivity Access Network |
| IP-M | IP Multicast |
| IPv4 | Internet Protocol Version 4 |
| IPv6 | Internet Protocol Version 6 |
| IR | Infrared |
| IS | In Sync |
| IRP | Integration Reference Point |
| ISDN | Integrated Services Digital Network |
| ISIM | IM Services Identity Module |
| ISO | International Organisation for Standardisation |
| ISP | Internet Service Provider |
| IWF | Interworking-Function |
| I-WLAN | Interworking WLAN |
| | Constraint length of the convolutional code, USIM Individual key |
| kB | Kilobyte (1000 bytes) |
| kbps | kilo-bits per second |
| Kc | Ciphering key |
| Ki | Individual subscriber authentication key |
| KPI | Key Performance Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal received power |
| L2 | Layer 2 (data link layer) |
| L3 | Layer 3 (network layer) |
| LAA | Licensed Assisted Access |
| LAN | Local Area Network |
| LADN | Local Area Data Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, Low Layer Compatibility |
| LPLMN | Local PLMN |
| LPP | LTE Positioning Protocol |
| LSB | Least Significant Bit |
| LTE | Long Term Evolution |
| LWA | LTE-WLAN aggregation |
| LWIP | LTE-WLAN Radio Level Integration with IPsec Tunnel |
| LTE | Long Term Evolution |
| M2M | Machine-to-Machine |
| MAC | Medium Access Control (protocol layering context) |
| MAC | Message authentication code (security/encryption context) |
| MAC-A | MAC used for authentication and key agreement (TSG T WG3 context) |
| MAC-I | MAC used for data integrity of signalling messages (TSG T WG3 context) |
| MANO | Management and Orchestration |
| MBMS | Multimedia Broadcast and Multicast Service |
| MBSFN | Multimedia Broadcast multicast service Single Frequency Network |
| MCC | Mobile Country Code |
| MCG | Master Cell Group |
| MCOT | Maximum Channel Occupancy Time |
| MCS | Modulation and coding scheme |
| MDAF | Management Data Analytics Function |
| MDAS | Management Data Analytics Service |
| MDT | Minimization of Drive Tests |
| ME | Mobile Equipment |
| MeNB | master eNB |
| MER | Message Error Ratio |
| MGL | Measurement Gap Length |
| MGRP | Measurement Gap Repetition Period |
| MIB | Master Information Block, Management Information Base |
| MIMO | Multiple Input Multiple Output |
| MLC | Mobile Location Centre |
| MM | Mobility Management |
| MME | Mobility Management Entity |
| MN | Master Node |
| MNO | Mobile Network Operator |
| MO | Measurement Object, Mobile Originated |
| MPBCH | MTC Physical Broadcast CHannel |
| MPDCCH | MTC Physical Downlink Control CHannel |
| MPDSCH | MTC Physical Downlink Shared CHannel |
| MPRACH | MTC Physical Random Access CHannel |
| MPUSCH | MTC Physical Uplink Shared Channel |
| MPLS | MultiProtocol Label Switching |
| MS | Mobile Station |
| MSB | Most Significant Bit |
| MSC | Mobile Switching Centre |
| MSI | Minimum System Information, MCH Scheduling Information |
| MSID | Mobile Station Identifier |
| MSIN | Mobile Station Identification Number |
| MSISDN | Mobile Subscriber ISDN Number |
| MT | Mobile Terminated, Mobile Termination |
| MTC | Machine-Type Communications |
| mMTC | massive MTC, massive Machine-Type Communications |
| MU-MIMO | Multi User MIMO |
| MWUS | MTC wake-up signal, MTC WUS |
| NACK | Negative Acknowledgement |
| NAI | Network Access Identifier |
| NAS | Non-Access Stratum, Non-Access Stratum layer |
| NCT | Network Connectivity Topology |
| NC-JT | Non-Coherent Joint Transmission |
| NEC | Network Capability Exposure |
| NE-DC | NR-E-UTRA Dual Connectivity |
| NEF | Network Exposure Function |
| NF | Network Function |
| NFP | Network Forwarding Path |
| NFPD | Network Forwarding Path Descriptor |
| NFV | Network Functions Virtualization |
| NFVI | NFV Infrastructure |
| NFVO | NFV Orchestrator |
| NG | Next Generation, Next Gen |
| NGEN-DC | NG-RAN E-UTRA-NR Dual Connectivity |
| NM | Network Manager |
| NMS | Network Management System |
| N-PoP | Network Point of Presence |
| NMIB, N-MIB | Narrowband MIB |
| NPBCH | Narrowband Physical Broadcast CHannel |
| NPDCCH | Narrowband Physical Downlink Control CHannel |
| NPDSCH | Narrowband Physical Downlink Shared CHannel |
| NPRACH | Narrowband Physical Random Access CHannel |
| NPUSCH | Narrowband Physical Uplink Shared CHannel |
| NPSS | Narrowband Primary Synchronization Signal |
| NSSS | Narrowband Secondary Synchronization Signal |
| NR | New Radio, Neighbour Relation |
| NRF | NF Repository Function |
| NRS | Narrowband Reference Signal |
| NS | Network Service |
| NSA | Non-Standalone operation mode |
| NSD | Network Service Descriptor |
| NSR | Network Service Record |
| NSSAI | Network Slice Selection Assistance Information |
| S-NNSAI | Single-NSSAI |
| NSSF | Network Slice Selection Function |
| NW | Network |
| NWUS | Narrowband wake-up signal, Narrowband WUS |
| NZP | Non-Zero Power |
| O&M | Operation and Maintenance |
| ODU2 | Optical channel Data Unit-type 2 |
| OFDM | Orthogonal Frequency Division Multiplexing |
| OFDMA | Orthogonal Frequency Division Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power Ratio |
| PAR | Peak to Average Ratio |
| PBCH | Physical Broadcast Channel |
| PC | Power Control, Personal Computer |
| PCC | Primary Component Carrier, Primary CC |
| PCell | Primary Cell |
| PCI | Physical Cell ID, Physical Cell Identity |
| PCEF | Policy and Charging Enforcement Function |
| PCF | Policy Control Function |
| PCRFPolicy | Control and Charging Rules Function |
| PDCP | Packet Data Convergence Protocol, Packet Data Convergence Protocol layer |
| PDCCH | Physical Downlink Control Channel |
| PDCP | Packet Data Convergence Protocol |
| PDN | Packet Data Network, Public Data Network |
| PDSCH | Physical Downlink Shared Channel |
| PDU | Protocol Data Unit |
| PEI | Permanent Equipment Identifiers |
| PFD | Packet Flow Description |
| P-GW | PDN Gateway |
| PHICH | Physical hybrid-ARQ indicator channel |
| PHY | Physical layer |
| PLMN | Public Land Mobile Network |
| PIN | Personal Identification Number |
| PM | Performance Measurement |
| PMI | Precoding Matrix Indicator |
| PNF | Physical Network Function |
| PNFD | Physical Network Function Descriptor |
| PNFR | Physical Network Function Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block group |
| ProSe | Proximity Services, Proximity-Based Service |
| PRS | Positioning Reference Signal |
| PRR | Packet Reception Radio |
| PS | Packet Services |
| PSBCH | Physical Sidelink Broadcast Channel |
| PSDCH | Physical Sidelink Downlink Channel |
| PSCCH | Physical Sidelink Control Channel |
| PSSCH | Physical Sidelink Shared Channel |
| PSCell | Primary SCell |
| PSS | Primary Synchronization Signal |
| PSTN | Public Switched Telephone Network |
| PT-RS | Phase-tracking reference signal |
| PTT | Push-to-Talk |
| PUCCII | Physical Uplink Control Channel |
| PUSCH | Physical Uplink Shared Channel |
| QAM | Quadrature Amplitude Modulation |
| QCL | Quasi co-location |
| QFI | QoS Flow ID, QoS Flow Identifier |
| QoS | Quality of Service |
| QPSK | Quadrature (Quaternary) Phase Shift Keying |
| QZSS | Quasi-Zenith Satellite System |
| RA-RNTI | Random Access RNTI |
| RAB | Radio Access Bearer, Random Access Burst |
| RACH | Random Access Channel |
| RADIUS | Remote Authentication Dial In User Service |
| RAN | Radio Access Network |
| RAND | RANDom number (used for authentication) |
| RAR | Random Access Response |
| RAT | Radio Access Technology |
| RAU | Routing Area Update |
| RB | Resource block, Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, Radio Link Control layer |
| RLC AM | RLC Acknowledged Mode |
| RLC UM | RLC Unacknowledged Mode |
| RLF | Radio Link Failure |
| RLM | Radio Link Monitoring |
| RLM-RS | Reference Signal for RLM |
| RM | Registration Management |
| RMC | Reference Measurement Channel |
| RMSI | Remaining MSI, Remaining Minimum System Information |
| RN | Relay Node |
| RNC | Radio Network Controller |
| RNL | Radio Network Layer |
| RNTI | Radio Network Temporary Identifier |
| ROHC | RObust Header Compression |
| RRC | Radio Resource Control, Radio Resource Control layer |
| RRM | Radio Resource Management |
| RS | Reference Signal |
| RSRP | Reference Signal Received Power |
| RSRQ | Reference Signal Received Quality |
| RSSI | Received Signal Strength Indicator |
| RSU | Road Side Unit |
| RSTD | Reference Signal Time difference |
| RTP | Real Time Protocol |
| RTS | Ready-To-Send |
| RTT | Round Trip Time |
| Rx | Reception, Receiving, Receiver |
| S1AP | S1 Application Protocol |
| S1-MMES1 | for the control plane |
| S1-U | S1 for the user plane |
| S-GW | Serving Gateway |
| S-RNTI | SRNC Radio Network Temporary Identity |
| S-TMSI | SAE Temporary Mobile Station Identifier |
| SA | Standalone operation mode |
| SAE | System Architecture Evolution |
| SAP | Service Access Point |
| SAPD | Service Access Point Descriptor |
| SAPI | Service Access Point Identifier |
| SCC | Secondary Component Carrier, Secondary CC |
| SCell | Secondary Cell |
| SCEF | Service Capability Exposure Function |
| SC-FDMA | Single Carrier Frequency Division Multiple Access |
| SCG | Secondary Cell Group |
| SCM | Security Context Management |
| SCS | Subcarrier Spacing |
| SCTP | Stream Control Transmission Protocol |
| SDAP | Service Data Adaptation Protocol, Service Data Adaptation Protocoll ayer |
| SDL | Supplementary Downlink |
| SDNF | Structured Data Storage Network Function |
| SDP | Session Description Protocol |
| SDSF | Structured Data Storage Function |
| SDU | Service Data Unit |
| SEAF | Security Anchor Function |
| SeNB | secondary eNB |
| SEPP | Security Edge Protection Proxy |
| SFI | Slot format indication |
| SFTD | Space-Frequency Time Diversity, SFN and frame timing difference |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management Function |
| SMS | Short Message Service |
| SMSF | SMS Function |
| SMTC | SSB-based Measurement Timing Configuration |
| SN | Secondary Node, Sequence Number |
| SoC | System on Chip |
| SON | Self-Organizing Network |
| SpCell | Special Cell |
| SP-CSI-RNTI | Semi-Persistent CSI RNTI |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | Synchronization Signal Block |
| SSID | Service Set Identifier |
| SS/PBCHI | Block |
| SSBRI | SS/PBCH Block Resource Indicator, Synchronization Signal Block Resource Indicator |
| SSC | Session and Service Continuity |
| SS-RSRP | Synchronization Signal based Reference Signal Received Power |
| SS-RSRQ | Synchronization Signal based Reference Signal Received Quality |
| SS-SINR | Synchronization Signal based Signal to Noise and Interference Ratio |
| SSS | Secondary Synchronization Signal |
| SSSG | Search Space Set Group |
| SSSIF | Search Space Set Indicator |
| SST | Slice/Service Types |
| SU-MIMO | Single User MIMO |
| SUL | Supplementary Uplink |
| TA | Timing Advance, Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission Configuration Indicator |
| TCP | Transmission Communication Protocol |
| TDM | Time Division Multiplexing |
| TDMA | Time Division Multiple Access |
| TE | Terminal Equipment |
| TEID | Tunnel End Point Identifier |
| TFT | Traffic Flow Template |
| TMSI | Temporary Mobile Subscriber Identity |
| TNL | Transport Network Layer |
| TPC | Transmit Power Control |
| TPMI | Transmitted Precoding Matrix Indicator |
| TR | Technical Report |
| TRP, TRxP | Transmission Reception Point |
| TRS | Tracking Reference Signal |
| TRx | Transceiver |
| TS | Technical Specifications, Technical Standard |
| TTI | Transmission Time Interval |
| Tx | Transmission, Transmitting, Transmitter |
| U-RNTI | UTRAN Radio Network Temporary Identity |
| UART | Universal Asynchronous Receiver and Transmitter |
| UCI | Uplink Control Information |
| UE | User Equipment |
| UDM | Unified Data Management |
| UDP | User Datagram Protocol |
| UDSF | Unstructured Data Storage Network Function |
| UICC | Universal Integrated Circuit Card |
| UL | Uplink |
| UM | Unacknowledged Mode |
| UML | Unified Modelling Language |
| UMTS | Universal Mobile Telecommunications System |
| UP | User Plane |
| UPF | User Plane Function |
| URI | Uniform Resource Identifier |
| URL | Uniform Resource Locator |
| URLLC | Ultra-Reliable and Low Latency |
| USB | Universal Serial Bus |
| USIM | Universal Subscriber Identity Module |
| USS | UE-specific search space |
| UTRA | UMTS Terrestrial Radio Access |
| UTRAN | Universal Terrestrial Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure Manager |
| VL | Virtual Link, |
| VLAN | Virtual LAN, Virtual Local Area Network |
| VM | Virtual Machine |
| VNF | Virtualized Network Function |
| VNFFG | VNF Forwarding Graph |
| VNFFGD | VNF Forwarding Graph Descriptor |
| VNFM | VNF Manager |
| VoIP | Voice-over-IP, Voice-over-Internet Protocol |
| VPLMN | Visited Public Land Mobile Network |
| VPN | Virtual Private Network |
| VRB | Virtual Resource Block |
| WiMAX | Worldwide Interoperability for Microwave Access |
| WLAN | Wireless Local Area Network |
| WMAN | Wireless Metropolitan Area Network |
| WPAN | Wireless Personal Area Network |
| X2-C | X2-Control plane |
| X2-U | X2-User plane |
| XML | eXtensible Markup Language |
| XRES | EXpected user RESponse |
| XOR | eXclusive OR |
| ZC | Zadoff-Chu |
| ZP | Zero Po |

1. An apparatus of a sensing entity at a User Equipment (UE) in a cellular network, the apparatus comprising:
processing circuitry to configure the sensing entity to:
generate and map sensing modulated symbols to time and frequency resource elements (REs) of an Orthogonal Frequency Division Multiplexing (OFDM) resource grid, following a supported configurations of fifth generation (5G) NR Downlink (DL) Positioning Reference Signal (PRS), or 5G NR Uplink (UL) PRS based on a 5G NR Sounding Reference Signal (SRS), respectively, in which one or more sensing block durations are defined related to durations of one or more PRS resource sets which are dependent on repetition parameters and a number of resources within each PRS resource set; and
transmit the modulated symbols in time and frequency resources; and
a memory configured to store the modulated symbols.

2. The apparatus of claim 1, wherein a frequency domain comb structure is used between two downlink (DL) PRS resource sets or two uplink (UL) PRS resource sets transmitted by a same entity over a same OFDM time domain.

3. The apparatus of claim 1, wherein a configuration of a DL PRS set supports configuring at least one of: two sets of values for {repetition gap, repetition factor}, a parameter indicating the relative offset between a starting of the two sets of repetitions, two values for the repetition factor, one indicating the maximum value to be used for sensing, and the other indicating the maximum value to be used for localization (positioning) of UEs, multiple PRS resources to use the same OFDM symbols and the same frequency resources by using cyclic shifts in time domain or frequency domain of a generated sequence over these resources, where the number and a size of cyclic shift windows is configured in relation to a numerology and a frequency domain comb-size and any prior information about a sensing environment.

4. The apparatus of claim 1, wherein a configuration of a UL PRS set also supports configuring at least one of: more than one values for a periodicity, a parameter indicating the relative offset between a starting of periodicities, a duration parameter indicating how long a periodic occurrences of UL-PRS resource sets continues for, or multiple PRS resources to use the same OFDM symbols and the same frequency resources by using cyclic shifts in time domain or frequency domain of a generated sequence over these resources, where the number and a size of cyclic shift windows is configured in relation to a numerology and a frequency domain comb-size and any prior information about a sensing environment.

5. The apparatus of claim 1, wherein the configuration of a DL PRS or a UL PRS supports configuring Quasi-Co-Location (QCL) relations between multiple resource sets or between resources in multiple resource sets.

6. The apparatus of claim 1, wherein the configuration of the DL PRS or the UL PRS support configuring PRS repetition gap in granularity of half-slot, where a repetition factor indicates a number of half-slots that it repeats.

7. The apparatus of claim 1, wherein the configuration of the DL PRS or the UL PRS support configuring PRS set to span over a first half of a slot and allows for configuring a repetition a gap of zero, in number of half-slots or slots.

8. The apparatus of claim 1, wherein one or more of DL PRS resource or DL PRS resource set, or UL-PRS resource or UL-PRS resource set configurations are configured or overridden through Downlink Control Information (DCI) signaling indication or via MAC Control Element (CE).

9. The apparatus of claim 1, wherein the configuration of the DL PRS or the UL PRS support configuring multiple beam directions in a same PRS resource by configuring cyclic shift values such that within a same PRS resource, different directions are multiplexed in a delay domain.

10. A non-transitory computer-readable medium storing computer-executable instructions which when executed by one or more processors of a base station (BS) result in performing operations comprising:
generating and map sensing modulated symbols to time and frequency resource elements (REs) of an Orthogonal Frequency Division Multiplexing (OFDM) resource grid, following a supported configurations of fifth generation (5G) NR Downlink (DL) Positioning Reference Signal (PRS), or 5G NR Uplink (UL) PRS based on a 5G NR Sounding Reference Signal (SRS), respectively, in which one or more sensing block durations are defined related to durations of one or more PRS resource sets which are dependent on repetition parameters and a number of resources within each PRS resource set; and
transmitting the modulated symbols in time and frequency resources.

11. The non-transitory computer-readable medium of claim 10, wherein a frequency domain comb structure is used between two downlink (DL) PRS resource sets or two uplink (UL) PRS resource sets transmitted by a same entity over a same OFDM time domain.

12. The non-transitory computer-readable medium of claim 10, wherein a configuration of a DL PRS set supports configuring at least one of: two sets of values for {repetition gap, repetition factor}, a parameter indicating the relative offset between a starting of the two sets of repetitions, two values for the repetition factor, one indicating the maximum value to be used for sensing, and the other indicating the maximum value to be used for localization (positioning) of UEs, multiple PRS resources to use the same OFDM symbols and the same frequency resources, or using cyclic shifts in time domain or frequency domain of a generated sequence over these resources, where the number and a size of cyclic shift windows is configured in relation to a numerology and a frequency domain comb-size and any prior information about a sensing environment.

13. The non-transitory computer-readable medium of claim 10, wherein a configuration of a UL PRS set also supports configuring at least one of: more than one values for a periodicity, a parameter indicating the relative offset between a starting of periodicities, a duration parameter indicating how long a periodic occurrences of UL-PRS resource sets continues for, or multiple PRS resources to use the same OFDM symbols and the same frequency resources, or using cyclic shifts in time domain or frequency domain of a generated sequence over these resources, where the number and a size of cyclic shift windows is configured in relation to a numerology and a frequency domain comb-size and any prior information about a sensing environment.

14. The non-transitory computer-readable medium of claim 10, wherein the configuration of a DL PRS or a UL PRS supports configuring Quasi-Co-Location (QCL) relations between multiple resource sets or between resources in multiple resource sets.

15. The non-transitory computer-readable medium of claim 10, wherein the configuration of the DL PRS or the UL PRS support configuring PRS repetition gap in granularity of half-slot, where a repetition factor indicates a number of half-slots that it repeats.

16. The non-transitory computer-readable medium of claim 10, wherein the configuration of the DL PRS or the UL PRS support configuring PRS set to span over a first half of a slot and allows for configuring a repetition a gap of zero, in number of half-slots or slots.

17. The non-transitory computer-readable medium of claim 10, wherein one or more of DL PRS resource or DL PRS resource set, or UL-PRS resource or UL-PRS resource set configurations are configured or overridden through Downlink Control Information (DCI) signaling indication or via MAC Control Element (CE).

18. The non-transitory computer-readable medium of claim 10, wherein the configuration of the DL PRS or the UL PRS support configuring multiple beam directions in a same PRS resource by configuring cyclic shift values such that within a same PRS resource, different directions are multiplexed in a delay domain.

19. A method comprising:
generating, by one or more processors, and map sensing modulated symbols to time and frequency resource elements (REs) of an Orthogonal Frequency Division Multiplexing (OFDM) resource grid, following a supported configurations of fifth generation (5G) NR Downlink (DL) Positioning Reference Signal (PRS), or 5G NR Uplink (UL) PRS based on a 5G NR Sounding Reference Signal (SRS), respectively, in which one or more sensing block durations are defined related to durations of one or more PRS resource sets which are dependent on repetition parameters and a number of resources within each PRS resource set; and
transmitting the modulated symbols in time and frequency resources.

20. The method of claim 19, wherein a frequency domain comb structure is used between two downlink (DL) PRS resource sets or two uplink (UL) PRS resource sets transmitted by a same entity over a same OFDM time domain.

21-25. (canceled)
